(19) United States
(12) Patent Application Publication
(10) Pub. No.: US 2025/0266206 A1
(43) Pub. Date: Aug. 21, 2025

(54) ELECTRONIC COMPONENT AND METHOD FOR MANUFACTURING THE SAME

(71) Applicant: Murata Manufacturing Co., Ltd., Kyoto-fu (JP)

(72) Inventors: Hiromitsu ITO, Nagaokakyo-shi (JP); Yuichi IIDA, Nagaokakyo-shi (JP)

(73) Assignee: Murata Manufacturing Co., Ltd., Kyoto-fu (JP)

(21) Appl. No.: 19/199,998

(22) Filed: May 6, 2025

Related U.S. Application Data
(63) Continuation of application No. PCT/JP2023/030131, filed on Aug. 22, 2023.

(30) Foreign Application Priority Data
Dec. 7, 2022 (JP) 2022-195680

(51) Int. Cl. H01F 27/29; H01G 4/005; H01G 4/10; H01G 4/33

(52) U.S. Cl. CPC H01F 27/292; H01G 4/005; H01G 4/10; H01G 4/33

(57) ABSTRACT

An electronic component capable of improving degree of freedom in design. The electronic component comprises glass board including top surface, bottom surface, first side surface, and second side surface, outer surface conductor that is provided on at least first side surface among first side surface and second side surface and is at least a part of passive element, and terminal electrode embedded in glass board so as to be exposed from bottom surface and electrically connected to outer surface conductor. A terminal electrode penetrates glass board from first side surface to second side surface, and height dimension of glass board, which is distance between top surface and bottom surface, is smaller than width dimension of glass board, which is distance between first side surface and second side surface.

### CROSS REFERENCE TO RELATED APPLICATION

This application claims benefit of priority to International Patent Application No. PCT/JP2023/030131, filed Aug. 22, 2023, and to Japanese Patent Application 2022-195680 filed Dec. 7, 2022, the entire content of each are incorporated herein by reference.

### BACKGROUND

### Technical Field

The present disclosure relates to an electronic component and a method for manufacturing the same.

### Background Art

Conventionally, as an electronic component, there is an electronic component described in JP-A-2020-174169. The electronic component includes a glass board including a bottom surface, a coil provided on the glass board, and a terminal electrode provided on the glass board and electrically connected to the coil. The bottom conductor of the coil is provided on the bottom surface of the glass board, and the terminal electrode is provided on the bottom surface of the glass board.

### SUMMARY

In the conventional electronic component, since the bottom conductor and the terminal electrode are provided on the same bottom surface of the glass board, the bottom conductor and the terminal electrode interfere with each other, and the degree of freedom in designing the electronic component cannot be improved.

Therefore, the present disclosure provides an electronic component capable of improving a degree of freedom in design and a method for manufacturing the electronic component.

Accordingly, an electronic component according to an aspect of the present disclosure includes a glass board including a top surface, a bottom surface, a first side surface, and a second side surface; an outer surface conductor that is provided on at least the first side surface of the first side surface and the second side surface and is at least a part of a passive element; and a terminal electrode embedded in the glass board so as to be exposed from the bottom surface and electrically connected to the outer surface conductor. The terminal electrode penetrates the glass board from the first side surface to the second side surface, and a height dimension of the glass board, which is a distance between the top surface and the bottom surface, is smaller than a width dimension of the glass board, which is a distance between the first side surface and the second side surface.

According to the above aspect, since the first side surface on which the outer surface conductor of the passive element is provided and the bottom surface on which the terminal electrode is provided are different surfaces, the outer surface conductor and the terminal electrode can be designed without being affected by each other, and the degree of freedom in designing the electronic component is improved.

In addition, since the terminal electrode penetrates the glass board from the first side surface to the second side surface, the terminal electrode extends in the width direction from the first side surface to the second side surface in a state of being embedded in the glass board. In the absence of the terminal electrode, when the height dimension is smaller than the width dimension, the glass board is easily bent in the height direction from the bottom surface toward the top surface, but since the terminal electrode extends in the width direction in a state of being embedded in the glass board, the bending strength of the glass board in the height direction can be improved.

Further, a method for manufacturing an electronic component according to one aspect of the present disclosure includes a step of preparing a glass mother board including a first surface and a second surface; a step of providing, in the first surface, two or more in a direction parallel to a first side, and two or more singulated regions in a direction parallel to the third side, the singulated regions being defined by the first side and a second side that have a length smaller than a distance between the first surface and the second surface and are parallel to each other, and the third side and a fourth side that are orthogonal to the first side and are parallel to each other; a step of forming a through hole penetrating the mother board from the first surface to the second surface in each of all the singulated regions, and filling a conductor in the through hole to form a terminal electrode; a step of forming an outer surface conductor that is at least a part of a passive element on the first surface in each of all the singulated regions; and a step of singulating each of all the singulated regions to manufacture a plurality of electronic components.

According to the above aspect, it is possible to manufacture an electronic component capable of improving the degree of freedom in design. In addition, it is possible to manufacture an electronic component capable of improving the bending strength of the glass board in the height direction.

According to the electronic component and the method for manufacturing the same according to one aspect of the present disclosure, the degree of freedom in designing the electronic component can be improved.

### BRIEF DESCRIPTION OF THE DRAWINGS

FIG. 1 is a side view of a first embodiment of an electronic component as viewed from a first side surface side.

FIG. 2 is a cross-sectional view taken along line II-II of FIG. 1.

FIG. 3A is an explanatory view for explaining a method for manufacturing an electronic component.

FIG. 3B is an explanatory view for explaining the method for manufacturing an electronic component.

FIG. 3C is an explanatory view for explaining the method for manufacturing an electronic component.

FIG. 3D is an explanatory view for explaining the method for manufacturing an electronic component.

FIG. 3E is an explanatory view for explaining the method for manufacturing an electronic component.

FIG. 4 is a side view of a second embodiment of an electronic component as viewed from a first side surface side.

FIG. 5 is a side view of a third embodiment of an electronic component as viewed from a first side surface side.

FIG. 6 is a cross-sectional view taken along line VI-VI of FIG. 5.

FIG. 7 is a side view of a fourth embodiment of an electronic component as viewed from a first side surface side.

FIG. 8 is a cross-sectional view taken along line VIII-VIII of FIG. 7.

FIG. 9 is a side view of a fifth embodiment of an electronic component as viewed from a first side surface side.

FIG. 10 is a side view of a sixth embodiment of an electronic component as viewed from a first side surface side.

FIG. 11 is a side view of a seventh embodiment of an electronic component as viewed from a first side surface side.

FIG. 12 is a side view of an electronic component according to an eighth embodiment as viewed from a first side surface side.

FIG. 13 is a side view of a ninth embodiment of an electronic component as viewed from a first side surface side.

FIG. 14 is a side view of a tenth embodiment of an electronic component as viewed from a first side surface side.

FIG. 15 is a side view of an eleventh embodiment of an electronic component as viewed from a first side surface side.

FIG. 16 is a cross-sectional view taken along line XVI-XVI of FIG. 15.

FIG. 17 is a side view of a twelfth embodiment of an electronic component as viewed from a first side surface side.

FIG. 18 is a side view of a thirteenth embodiment of an electronic component as viewed from a first side surface side.

FIG. 19 is a side view of a fourteenth embodiment of an electronic component as viewed from a first side surface side.

FIG. 20 is a cross-sectional view taken along line XX-XX of FIG. 19.

### DETAILED DESCRIPTION

Hereinafter, an electronic component according to one aspect of the present disclosure will be described in detail with reference to the illustrated embodiments. Note that the drawings include some schematic drawings, and may not reflect actual dimensions and ratios.

### First Embodiment

### [Overview Configuration]

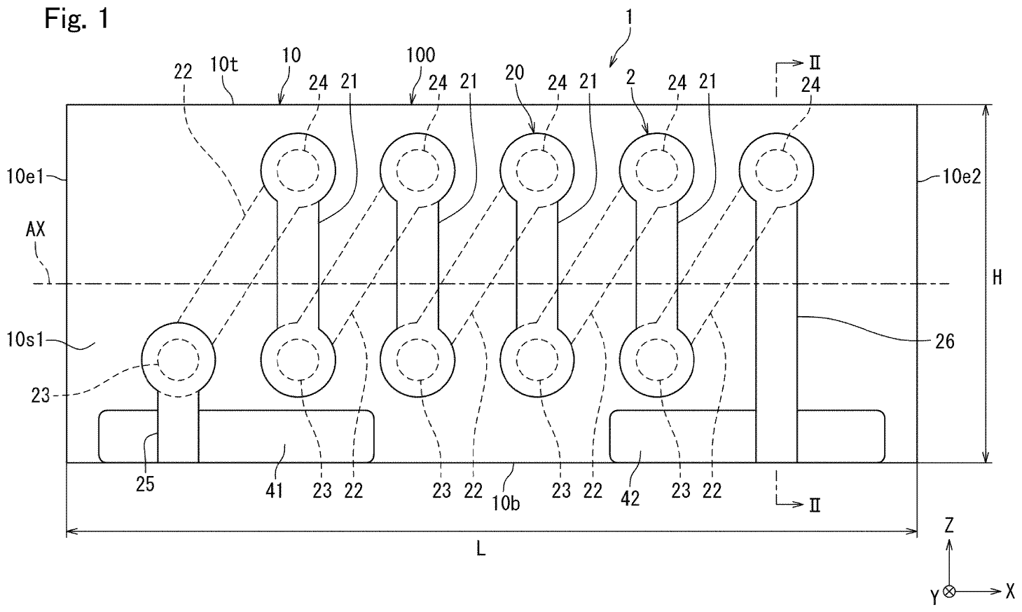

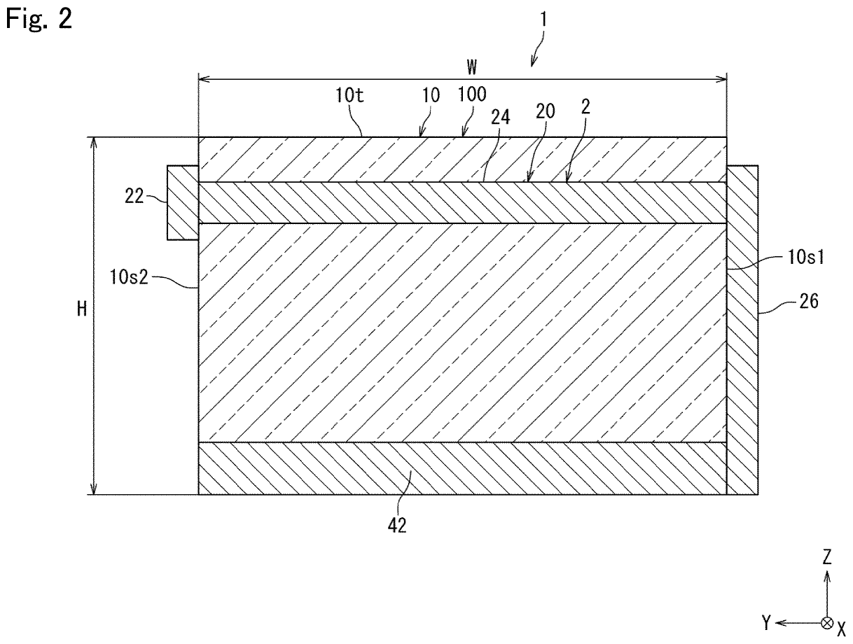

FIG. 1 is a side view of an electronic component 1 as viewed from a first side surface side. FIG. 2 is a cross-sectional view taken along line II-II of FIG. 1. As shown in FIGS. 1 and 2, the electronic component 1 includes a glass board 10, an inductor element 2, a first terminal electrode 41, and a second terminal electrode 42. The inductor element 2 corresponds to an example of a “passive element” described in the claims. The electronic component 1 is, for example, a surface mount electronic component used for a high frequency signal transmission circuit.

The glass board 10 has a top surface 10t and a bottom surface 10b located on opposite sides, and a first side surface 10s1 and a second side surface 10s2 located on opposite sides.

The inductor element 2 includes a first coil conductor 21 provided on the first side surface 10s1 and a second coil conductor 22 provided on the second side surface 10s2. The first coil conductor 21 and the second coil conductor 22 correspond to an example of an “outer surface conductor” described in the claims.

Each of the first terminal electrode 41 and the second terminal electrode 42 is embedded in the glass board 10 so as to be exposed from the bottom surface 10b, and is electrically connected to the first coil conductor 21 and the second coil conductor 22.

The first terminal electrode 41 and the second terminal electrode 42 each penetrate the glass board 10 from the first side surface 10s1 to the second side surface 10s2. A height dimension H of the glass board 10, which is a distance between the top surface 10t and the bottom surface 10b, is smaller than a width dimension W of the glass board 10, which is a distance between the first side surface 10s1 and the second side surface 10s2.

Here, the relationship of “the height dimension H is smaller than the width dimension W” refers to a relationship satisfying at least one of “the maximum distance (height dimension H) between the top surface 10t and the bottom surface 10b is smaller than the minimum distance (width dimension W) between the first side surface 10s1 and the second side surface 10s2” or “an average distance (height dimension H) between the top surface 10t and the bottom surface 10b is smaller than an average distance (width dimension W) between the first side surface 10s1 and the second side surface 10s2”.

According to the above configuration, since the first side surface 10s1 on which the first coil conductor 21 is provided and the second side surface 10s2 on which the second coil conductor 22 is provided are surfaces different from the bottom surface 10b on which the first terminal electrode 41 and the second terminal electrode 42 are provided, the first coil conductor 21 and the second coil conductor 22 and the first terminal electrode 41 and the second terminal electrode 42 can be designed without being affected by each other, and the degree of freedom in designing the electronic component 1 is improved.

In addition, since the first terminal electrode 41 and the second terminal electrode 42 each penetrate the glass board 10 from the first side surface 10s1 to the second side surface 10s2, the first terminal electrode 41 and the second terminal electrode 42 each extend in the width direction (Y direction) from the first side surface 10s1 to the second side surface 10s2 in a state of being embedded in the glass board 10. In the absence of the first terminal electrode 41 and the second terminal electrode 42, when the height dimension H is smaller than the width dimension W, the glass board 10 is easily bent in the height direction (Z direction) from the bottom surface 10b toward the top surface 10t, but since the first terminal electrode 41 and the second terminal electrode 42 extend in the width direction in a state of being embedded in the glass board 10, the bending strength of the glass board 10 in the height direction can be improved.

In addition, since the height dimension H is smaller than the width dimension W, the height dimension H of the glass board 10 can be reduced, whereby the height of the electronic component 1 can be reduced.

Note that the passive element may be a capacitor element, a resistor, or the like instead of the inductor element. Further, the outer surface conductor which is at least a part of the passive element may be provided on at least the first side surface among the first side surface and the second side surface. In addition, at least one terminal electrode may be provided. [Preferred Configuration of Each Member]

### (Glass Board 10)

The glass board 10 is a rectangular parallelepiped having a length, a width, and a height. The glass board 10 has a first end surface 10e1 and a second end surface 10e2 on both end sides in the length direction, a first side surface 10s1 and a second side surface 10s2 on both end sides in the width direction, and a bottom surface 10b and a top surface 10t on both end sides in the height direction. That is, an outer surface 100 of the glass board 10 includes the first end surface 10e1 and the second end surface 10e2, the first side surface 10s1 and the second side surface 10s2, and the bottom surface 10b and the top surface 10t. The bottom surface 10b is a surface facing the mounting substrate side when the electronic component 1 is mounted on the mounting substrate.

In this specification, the outer surface 100 of the glass board 10 does not simply mean a surface facing the outer peripheral side of the glass board 10, but is a surface serving as a boundary between the outside and the inside of the glass board 10. In addition, “above the outer surface 100 of the glass board 10” refers to not an absolute direction such as a vertical upward direction defined in the direction of gravity, but a direction toward the outside with respect to the outer surface 100 as a boundary between the outside and the inside with the outer surface 100 as a reference. Therefore, “above the outer surface 100” is a relative direction determined by the direction of the outer surface 100. In addition, “above” with respect to an element includes not only an upper position away from the element, that is, an upper position via another object on the element or a spaced-apart upper position, but also a position (on) immediately above the element in contact with the element.

Hereinafter, for convenience of description, a direction from the first end surface 10e1 to the second end surface 10e2 in the length direction (longitudinal direction) of the glass board 10 is referred to as an X direction. In addition, a direction from the first side surface 10s1 toward the second side surface 10s2 in the width direction of the glass board 10 is defined as a Y direction. In addition, a direction from the bottom surface 10b toward the top surface 10t in the height direction of the glass board 10 is defined as a Z direction. The X direction, the Y direction, and the Z direction are directions orthogonal to each other, and form a right-handed coordinate system when arranged in the order of X, Y, and Z.

The glass board 10 has an insulating property. The glass board 10 is preferably, for example, a glass board having photosensitivity represented by FoturanII (registered trademark of SchottAG). In particular, the glass board 10 preferably contains cerium oxide (ceria: CeO2), and in this case, the cerium oxide serves as a sensitizer, and processing by photolithography becomes easier.

However, since the glass board 10 can be processed by machining such as drilling and sandblasting, dry/wet etching processing using a photoresist/metal mask, laser processing, or the like, it may be a glass plate having no photosensitivity. The glass board 10 may be obtained by sintering a glass paste, or may be formed by a known method such as a float method.

The height dimension H of the glass board 10 is smaller than the width dimension W of the glass board 10. A length dimension L of the glass board 10, which is a distance between the first end surface 10e1 and the second end surface 10e2, is larger than the width dimension W of the glass board 10.

Here, the relationship of “the length dimension Lis smaller than the width dimension W” refers to a relationship satisfying at least one of “the maximum distance (length dimension L) between the first end surface 10e1 and the second end surface 10e2 is smaller than the minimum distance (width dimension W) between the first side surface 10s1 and the second side surface 10s2” or “an average distance (length dimension L) between the first end surface 10e1 and the second end surface 10e2 is smaller than an average distance (width dimension W) between the first side surface 10s1 and the second side surface 10s2”.

### (Inductor Element 2)

The inductor element 2 includes a coil 20, a first lead conductor 25 connected to a first end of the coil 20, and a second lead conductor 26 connected to a second end of the coil 20. The coil 20 is spirally wound along the axis AX. The first lead conductor 25 is connected to the first terminal electrode 41. The second lead conductor 26 is connected to the second terminal electrode 42.

The axis AX of the coil 20 is arranged parallel to the bottom surface 10b of the glass board 10. According to this, when the electronic component 1 is mounted on the mounting substrate such that the bottom surface 10b of the glass board 10 faces the mounting substrate, the axis AX of the coil 20 is horizontal to the mounting substrate, so that the decrease in the L value and the Q value due to the eddy current flowing through the mounting substrate hardly occurs. “Parallel” includes not only that the axis AX is completely parallel to the bottom surface 10b, but also that the axis AX is substantially parallel, for example, slightly inclined with respect to the bottom surface 10b.

The coil 20 includes a plurality of first coil conductors 21, a plurality of second coil conductors 22, a plurality of first through conductors 23, and a plurality of second through conductors 24. In the coil 20, the first through conductor 23, the second coil conductor 22, the second through conductor 24, and the first coil conductor 21 are electrically connected in this order to form a spiral. The number of turns of the coil 20 is a plurality of turns. The number of turns of the coil 20 may be less than 1 turn.

The plurality of first through conductors 23 penetrate the glass board 10 from the first side surface 10s1 to the second side surface 10s2. Therefore, the plurality of first through conductors 23 extend in the width direction (Y direction) in a state of being embedded in the glass board 10. Therefore, the bending strength of the glass board 10 in the height direction (Z direction) can be further improved.

The plurality of first through conductors 23 extend from the second coil conductor 22 toward the first coil conductor 21 and are arranged along the axis AX. The first through conductor 23 extends in a direction orthogonal to the first side surface 10s1 and the second side surface 10s2. All the first through conductors 23 are arranged in parallel along the X direction. The first through conductors 23 are arranged on the bottom surface 10b side with respect to the axis AX.

The plurality of second through conductors 24 penetrate the glass board 10 from the first side surface 10s1 to the second side surface 10s2. Therefore, the plurality of second through conductors 24 extend in the width direction (Y direction) in a state of being embedded in the glass board 10. Therefore, the bending strength of the glass board 10 in the height direction (Z direction) can be further improved.

The plurality of second through conductors 24 extend from the second coil conductor 22 toward the first coil conductor 21 and are arranged along the axis AX. The second through conductor 24 extends in a direction orthogonal to the first side surface 10s1 and the second side surface 10s2. All the second through conductors 24 are arranged in parallel along the X direction. The second through conductor 24 is provided on the side opposite to the first through conductor 23 with respect to the axis AX. That is, the second through conductor 24 is arranged on the top surface 10t side with respect to the axis AX.

The plurality of first coil conductors 21 are provided on the first side surface 10s1. The first coil conductor 21 has a shape extending in the Z direction. All the first coil conductors 21 are arranged in parallel along the X direction. The first end (pad portion) of the first coil conductor 21 is connected to the end of the first through conductor 23. The second end (pad portion) of the first coil conductor 21 is connected to the end of the second through conductor 24.

The plurality of second coil conductors 22 are provided on the second side surface 10s2. The second coil conductor 22 is slightly inclined in the X direction and extends in the Z direction. All the second coil conductors 22 are arranged in parallel along the X direction. The first end (pad portion) of the second coil conductor 22 is connected to the end of the first through conductor 23. The second end (pad portion) of the second coil conductor 22 is connected to the end of the second through conductor 24.

The first lead conductor 25 is provided on the first side surface 10s1. The first lead conductor 25 has a shape extending in the Z direction. The first end (pad portion) of the first lead conductor 25 is connected to the end of the first through conductor 23. The second end of the first lead conductor 25 is connected to the side surface of the first terminal electrode 41.

The second lead conductor 26 is provided on the first side surface 10s1. The second lead conductor 26 has a shape extending in the Z direction. The first end (pad portion) of the second lead conductor 26 is connected to the end of the second through conductor 24. The second end of the second lead conductor 26 is connected to the side surface of the second terminal electrode 42.

The first coil conductor 21 and the second coil conductor 22 are made of a conductive material such as copper, silver, gold, or an alloy thereof. The first coil conductor 21 and the second coil conductor 22 may be a metal film formed by plating, vapor deposition, sputtering, or the like, or may be a metal sintered body obtained by applying and sintering a conductor paste. The materials of the first through conductor 23 and the second through conductor 24 are the same as the materials of the first coil conductor 21 and the second coil conductor 22.

The first coil conductor 21 and the second coil conductor 22 are preferably formed by a semi-additive method, whereby the first coil conductor 21 and the second coil conductor 22 having low electric resistance, high accuracy, and high aspect ratio can be formed. The first through conductor 23 and the second through conductor 24 can be formed in a through hole formed in advance in the glass board 10 using the materials and manufacturing methods exemplified for the first coil conductor 21 and the second coil conductor 22.

The first lead conductor 25 and the second lead conductor 26 can be formed by the same material and method as those of the first coil conductor.

### (First Terminal Electrode 41 and Second Terminal Electrode 42)

The first terminal electrode 41 is embedded in the glass board 10 so as to be exposed from the bottom surface 10b, the first side surface 10s1, and the second side surface 10s2. The first terminal electrode 41 is provided on the first end surface 10e1 side with respect to the center of the glass board 10 in the X direction.

The second terminal electrode 42 is embedded in the glass board 10 so as to be exposed from the bottom surface 10b, the first side surface 10s1, and the second side surface 10s2. The second terminal electrode 42 is provided on the second end surface 10e2 side with respect to the center of the glass board 10 in the X direction.

The first terminal electrode 41 and the second terminal electrode 42 can be formed by the same material and method as those of the first coil conductor. The first terminal electrode 41 and the second terminal electrode 42 may have a plating layer.

The first terminal electrode 41 is connected to the first lead conductor 25 which is the first end of the inductor element 2. The second terminal electrode 42 is connected to the second lead conductor 26 which is the second end of the inductor element 2.

### (Method for Manufacturing Electronic Component 1)

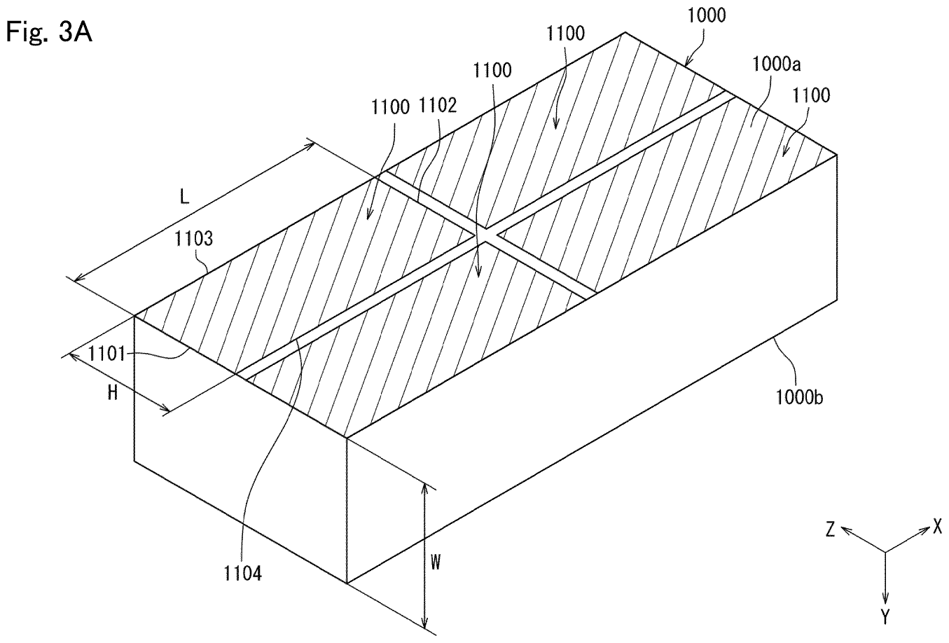

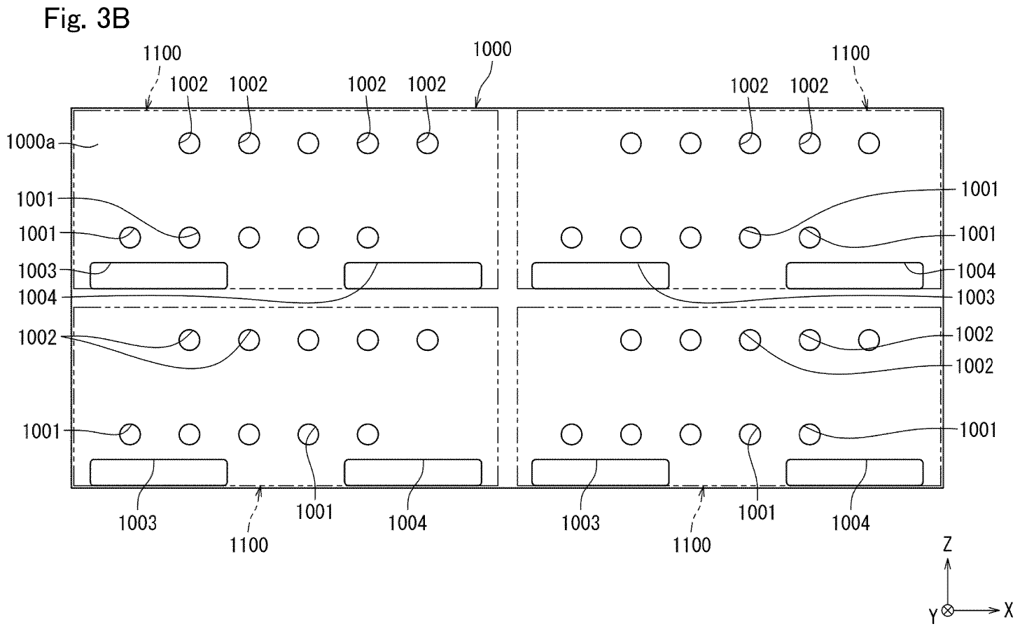

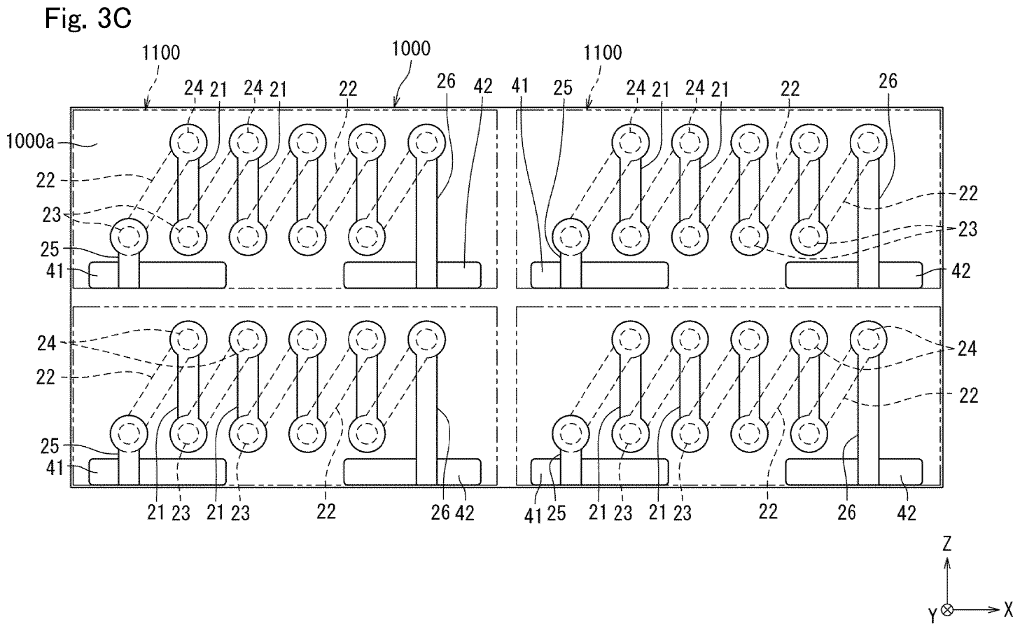

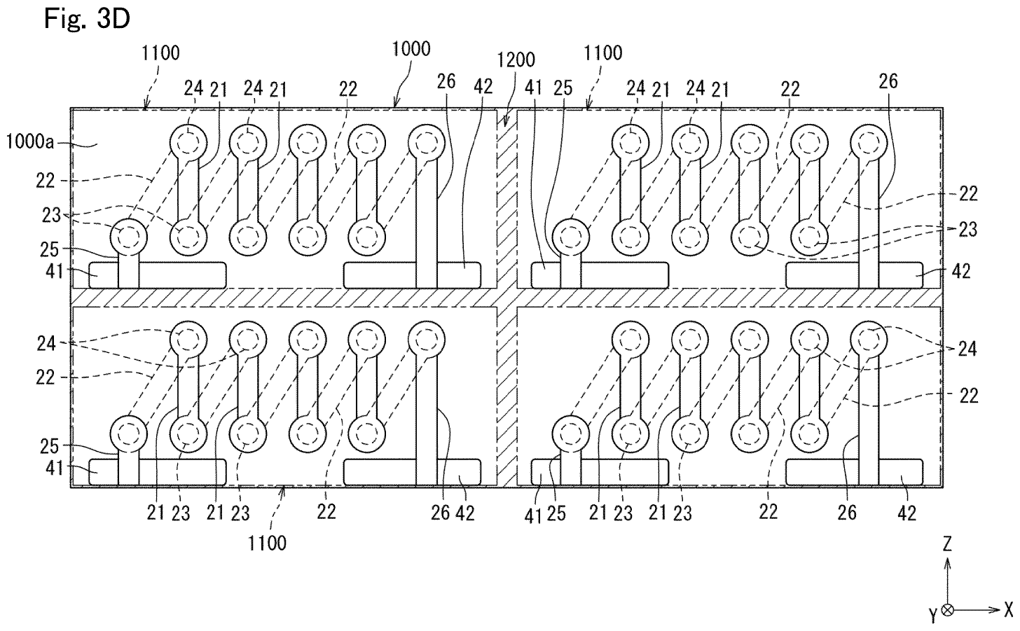

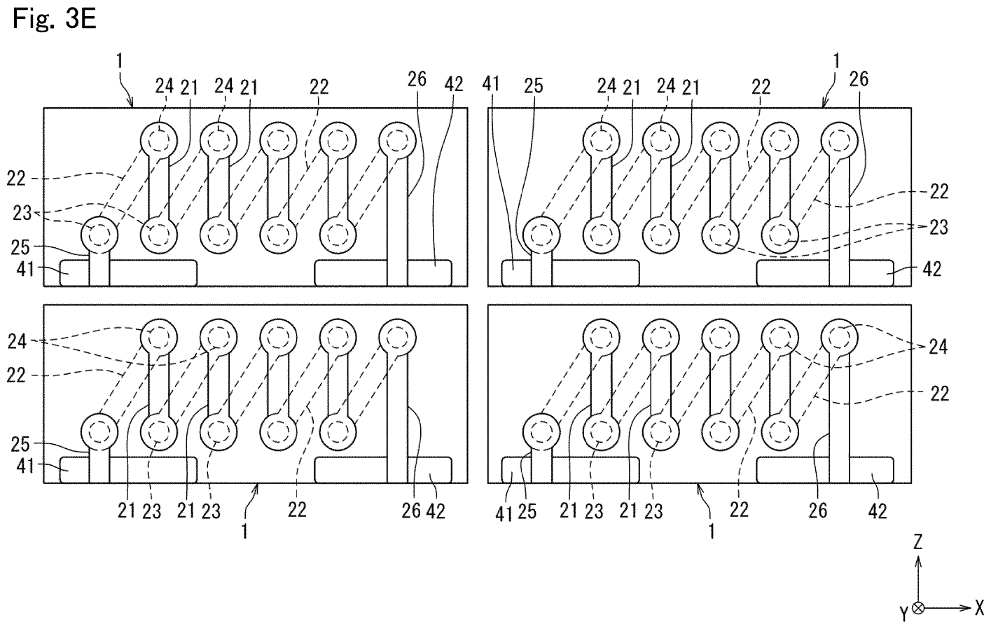

Next, a method for manufacturing the electronic component 1 will be described with reference to FIGS. 3A to 3E.

As shown in FIG. 3A, a glass mother board 1000 including a first surface 1000a and a second surface 1000b is prepared. The first surface 1000a includes the first side surface 10s1, and the second surface 1000b includes the second side surface 10s2. As the mother board 1000, for example, FoturanII can be used. Since the mother board 1000 generally contains an oxide such as silicon, lithium, aluminum, or cerium, it can cope with high-precision photolithography.

A plurality of singulated regions 1100 are provided on the first surface 1000a. In FIG. 3A, the singulated region 1100 is indicated by hatching. The singulated region 1100 is defined by a first side 1101, a second side 1102, a third side 1103, and a fourth side 1104. The first side 1101 and the second side 1102 are parallel to each other, and the third side 1103 and the fourth side 1104 are parallel to each other. The third side 1103 and the fourth side 1104 are orthogonal to the first side 1101. That is, the singulated region 1100 has a quadrangular shape.

The first side 1101 and the second side 1102 each have a length smaller than the distance between the first surface 1000a and the second surface 1000b. The distance between the first surface 1000a and the second surface 1000b corresponds to the dimension W of the glass board 10. The length of each of the first side 1101 and the second side 1102 corresponds to the height dimension H of the glass board 10. The length of each of the third side 1103 and the fourth side 1104 corresponds to the length dimension L of the glass board 10.

Two or more singulated regions 1100 are provided in a direction (Z direction) parallel to the first side 1101, and two or more singulated regions 1100 are provided in a direction (X direction) parallel to the third side 1103. In this embodiment, a total of four singulated regions 1100, two in the Z direction and two in the X direction, are provided.

As shown in FIG. 3B, in each of all the singulated regions 1100, a first through hole 1001, a second through hole 1002, a third through hole 1003, and a fourth through hole 1004 penetrating the mother board 1000 from the first surface 1000a to the second surface 1000b are formed. In FIG. 3B, the singulated region 1100 is indicated by a two-dot chain line.

The first through hole 1001 is a portion where the first through conductor 23 is formed. The second through hole 1002 is a portion where the second through conductor 24 is formed. The third through hole 1003 is a portion where the first terminal electrode 41 is formed. The fourth through hole 1004 is a portion where the second terminal electrode 42 is formed.

As a method for forming the first to fourth through holes 1001 to 1004, for example, a portion where the through hole is to be formed is irradiated with ultraviolet rays and crystallized by heat treatment (for example, firing) to form a crystallized portion, and the crystallized portion is removed by etching to form the through hole.

As shown in FIG. 3C, the first through hole 1001 is filled with a conductor to form the first through conductor 23. The second through hole 1002 is filled with a conductor to form the second through conductor 24. The third through hole 1003 is filled with a conductor to form the first terminal electrode 41. The fourth through hole 1004 is filled with a conductor to form the second terminal electrode 42. The first through conductor 23, the second through conductor 24, the first terminal electrode 41, and the second terminal electrode 42 are formed by, for example, a semi-additive method.

Thereafter, in each of all the singulated regions 1100, the first coil conductor 21, the first lead conductor 25, and the second lead conductor 26 are formed on the first surface 1000a, and the second coil conductor 22 is formed on the second surface 1000b.

As shown in FIG. 3D, a cut region 1200 between the adjacent singulated regions 1100 is irradiated with ultraviolet rays and crystallized by heat treatment (for example, firing) to form a crystallized portion. The cut region 1200 corresponds to a cutting line when the mother board 1000 is divided into individual pieces. In FIG. 3D, a crystallized portion of the cut region 1200 is indicated by hatching for convenience.

The crystallized portion of the cut region 1200 is removed by etching, and as shown in FIG. 3E, each of all the singulated regions 1100 is divided to manufacture a plurality of electronic components 1. Although the mother board 1000 is singulated by etching the crystallized portion, the mother board 1000 may be singulated by a dicer, a laser, or the like.

According to the above manufacturing method, since the mother board 1000 having two singulated regions 1100 in the Z direction and two singulated regions 1100 in the X direction is segmented, the mother board 1000 is less likely to be cracked. On the other hand, in a case where the mother board having two or more singulated regions only in the X direction is singulated, the height dimension H is smaller than the width dimension W in each singulated region, and thus, when the mother board is cut from the Z direction, the mother board is cut along a direction in which the height dimension His smaller. As described above, the mother board is cut along a direction in which the strength of the mother board is weak, so that the glass board is likely to be cracked.

### Second Embodiment

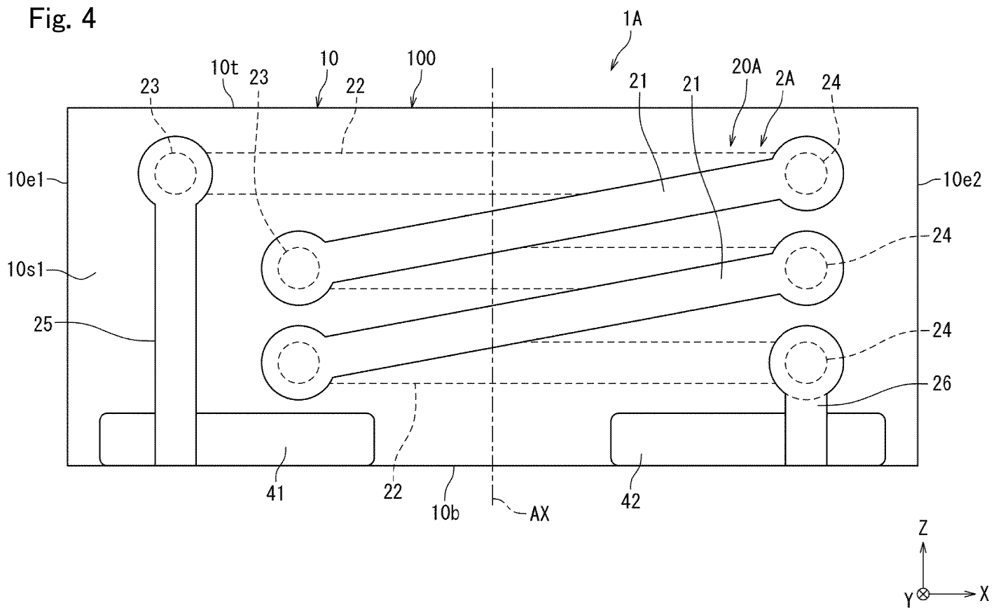

FIG. 4 is a side view of a second embodiment of an electronic component as viewed from a first side surface side. The second embodiment is different from the first embodiment in the position of the coil of the inductor element. This different configuration will be described below. The other configurations are the same as those of the first embodiment, and are denoted by the same reference numerals as those of the first embodiment, and the description thereof will be omitted.

As shown in FIG. 4, in an electronic component 1A of the second embodiment, an axis AX of a coil 20A of an inductor element 2A is perpendicular to a bottom surface 10b of a glass board 10. According to this, when the electronic component 1A is mounted on the mounting substrate such that the bottom surface 10b of the glass board 10 faces the mounting substrate, the axis AX of the coil 20A is perpendicular to the mounting substrate, so that magnetic coupling between the electronic component 1A and another component adjacent thereto can be reduced on the mounting substrate. The term “perpendicular” includes not only that the axis AX is completely perpendicular to the bottom surface 10b but also that the axis AX and the bottom surface 10b are substantially perpendicular, for example, an angle formed by the axis AX and the bottom surface 10b is 80° to 100°.

The plurality of first through conductors 23 penetrate the glass board 10 from the first side surface 10s1 to the second side surface 10s2. All the first through conductors 23 are arranged in parallel along the Z direction. The first through conductors 23 are arranged on the first end surface 10e1 side with respect to the axis AX.

The plurality of second through conductors 24 penetrate the glass board 10 from the first side surface 10s1 to the second side surface 10s2. All the second through conductors 24 are arranged in parallel along the Z direction. The second through conductor 24 is provided on the side opposite to the first through conductor 23 with respect to the axis AX. That is, the second through conductor 24 is arranged on the second end surface 10e2 side with respect to the axis AX.

The plurality of first coil conductors 21 are provided on the first side surface 10s1. The first coil conductor 21 is slightly inclined in the Z direction and extends in the X direction. All the first coil conductors 21 are arranged in parallel along the Z direction.

The plurality of second coil conductors 22 are provided on the second side surface 10s2. The second coil conductor 22 extends in the X direction. All the second coil conductors 22 are arranged in parallel along the Z direction.

The electronic component 1A of the second embodiment has the same effect as that of the electronic component 1 of the first embodiment. That is, according to the above configuration, since the first side surface 10s1 on which the first coil conductor 21 is provided and the second side surface 10s2 on which the second coil conductor 22 is provided are surfaces different from the bottom surface 10b on which the first terminal electrode 41 and the second terminal electrode 42 are provided, the first coil conductor 21 and the second coil conductor 22 and the first terminal electrode 41 and the second terminal electrode 42 can be designed without being affected by each other, and the degree of freedom in designing the electronic component 1A is improved.

In addition, since the first terminal electrode 41 and the second terminal electrode 42 each penetrate the glass board 10 from the first side surface 10s1 to the second side surface 10s2, the first terminal electrode 41 and the second terminal electrode 42 each extend in the width direction (Y direction) from the first side surface 10s1 to the second side surface 10s2 in a state of being embedded in the glass board 10. As a result, the bending strength of the glass board 10 in the height direction (Z direction) can be improved.

In addition, since the height dimension H is smaller than the width dimension W, the height dimension H of the glass board 10 can be reduced, whereby the height of the electronic component 1A can be reduced.

The plurality of first through conductors 23 extend in the width direction (Y direction) in a state of being embedded in the glass board 10. Therefore, the bending strength of the glass board 10 in the height direction (Z direction) can be further improved.

The plurality of second through conductors 24 extend in the width direction (Y direction) in a state of being embedded in the glass board 10. Therefore, the bending strength of the glass board 10 in the height direction (Z direction) can be further improved.

### Third Embodiment

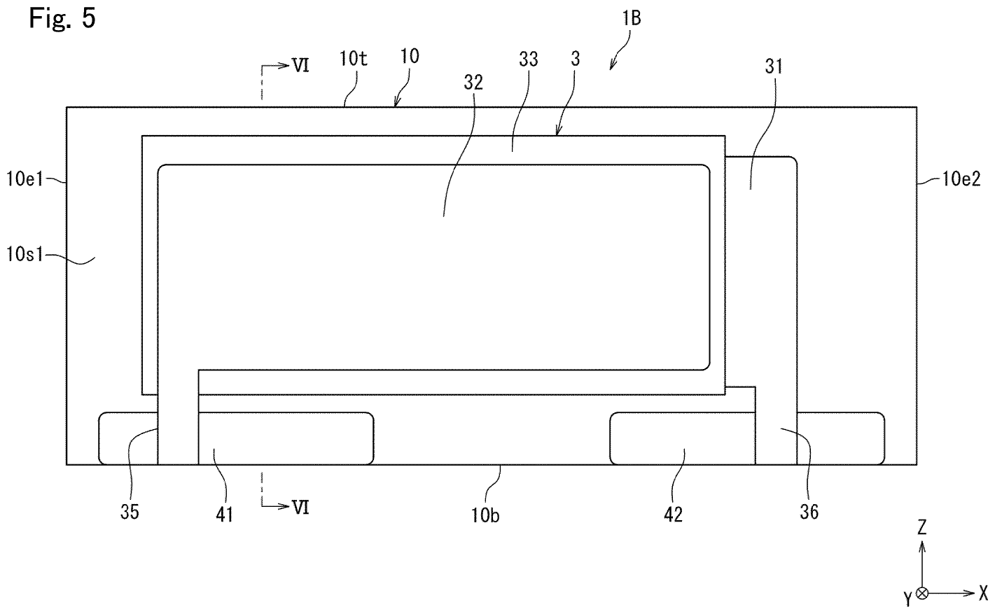

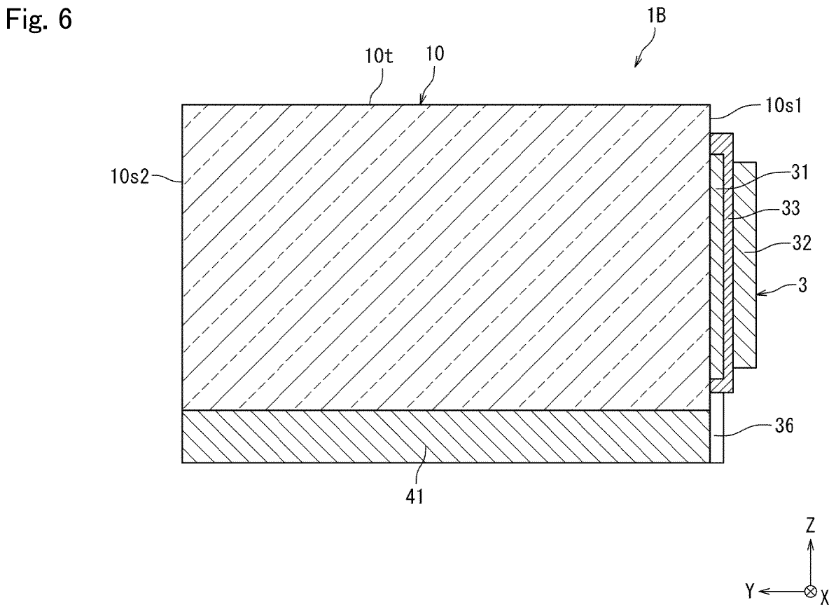

FIG. 5 is a side view of a third embodiment of an electronic component as viewed from a first side surface side. FIG. 6 is a cross-sectional view taken along line VI-VI in FIG. 5. The third embodiment is different from the first embodiment in the configuration of the passive element. This different configuration will be described below. The other configurations are the same as those of the first embodiment, and are denoted by the same reference numerals as those of the first embodiment, and the description thereof will be omitted.

As shown in FIGS. 5 and 6, in an electronic component 1B of the third embodiment, the passive element is a capacitor element 3. The capacitor element 3 includes a first flat plate electrode 31, a second flat plate electrode 32, a dielectric film 33, a first lead conductor 35, and a second lead conductor 36. The first flat plate electrode 31, the second flat plate electrode 32, the first lead conductor 35, and the second lead conductor 36 correspond to an example of an “outer surface conductor” described in the claims.

The first flat plate electrode 31 is provided on the first side surface 10s1, and the second flat plate electrode 32 is provided on the first flat plate electrode 31. The dielectric film 33 is provided between the first flat plate electrode 31 and the second flat plate electrode 32. Each of the first flat plate electrode 31 and the second flat plate electrode 32 extends along the X direction. The dielectric film 33 extends along the X direction and covers both ends of the first flat plate electrode 31 in the Z direction.

The first lead conductor 35 is provided on the first side surface 10s1. The first lead conductor 35 has a shape extending in the Z direction. The first end of the first lead conductor 35 is connected to the second flat plate electrode 32. The second end of the first lead conductor 35 is connected to the side surface of the first terminal electrode 41.

The second lead conductor 36 is provided on the first side surface 10s1. The second lead conductor 36 has a shape extending in the Z direction. The first end of the second lead conductor 36 is connected to the first flat plate electrode 31. The second end of the second lead conductor 36 is connected to the side surface of the second terminal electrode 42.

According to the electronic component 1B of the second embodiment, stray capacitance between the electronic component 1B and the ground of the mounting substrate is less likely to occur as compared with the case where the capacitor element 3 is provided on the bottom surface 10b. In addition, the parasitic inductance can be reduced as compared with the case where the capacitor element 3 is provided on the top surface 10t.

The electronic component 1B of the second embodiment has the same effect as that of the electronic component 1 of the first embodiment. That is, since the first side surface 10s1 on which the first flat plate electrode 31 and the second flat plate electrode 32 are provided is a surface different from the bottom surface 10b on which the first terminal electrode 41 and the second terminal electrode 42 are provided, the first flat plate electrode 31 and the second flat plate electrode 32 and the first terminal electrode 41 and the second terminal electrode 42 can be designed without being affected by each other, and the degree of freedom in designing the electronic component 1B is improved.

In addition, since the first terminal electrode 41 and the second terminal electrode 42 each penetrate the glass board 10 from the first side surface 10s1 to the second side surface 10s2, the first terminal electrode 41 and the second terminal electrode 42 each extend in the width direction (Y direction) from the first side surface 10s1 to the second side surface 10s2 in a state of being embedded in the glass board 10. As a result, the bending strength of the glass board 10 in the height direction (Z direction) can be improved.

In addition, since the height dimension H is smaller than the width dimension W, the height dimension H of the glass board 10 can be reduced, whereby the height of the electronic component 1B can be reduced.

### Fourth Embodiment

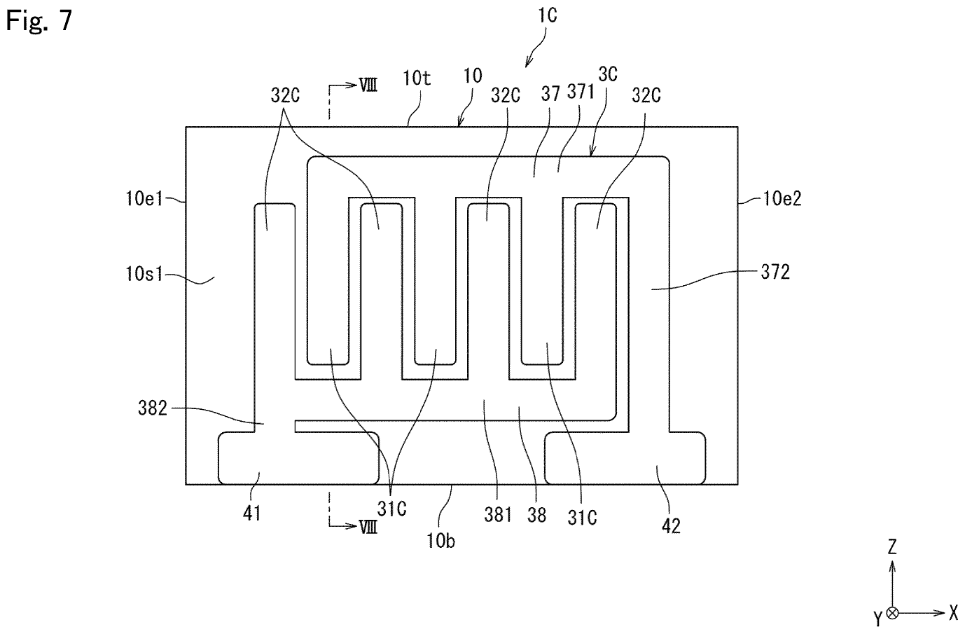

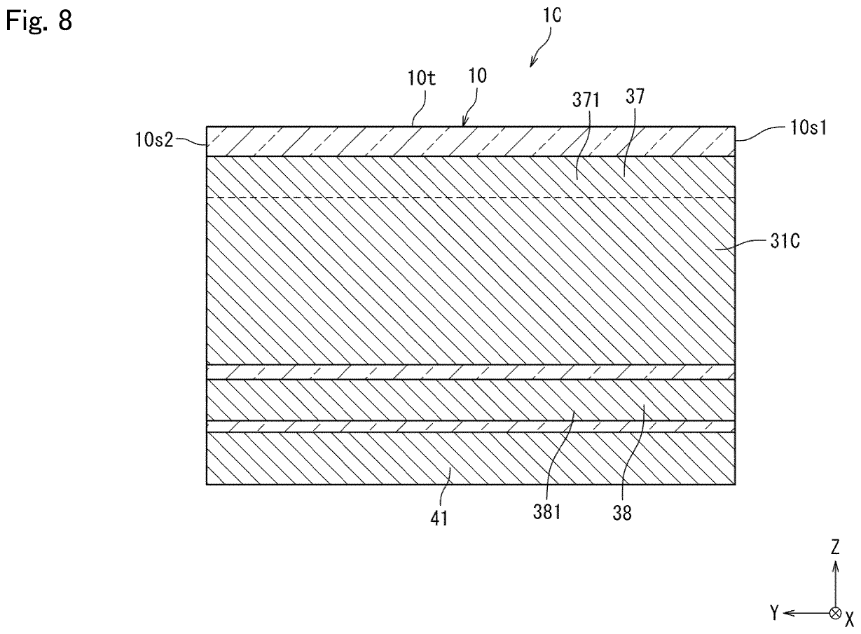

FIG. 7 is a side view of a fourth embodiment of an electronic component as viewed from a first side surface side. FIG. 8 is a cross-sectional view taken along line VIII-VIII of FIG. 7. The fourth embodiment is different from the third embodiment in the configuration of the capacitor element. This different configuration will be described below. The other configurations are the same as those of the third embodiment, and are denoted by the same reference numerals as those of the third embodiment, and the description thereof will be omitted.

As shown in FIGS. 7 and 8, in an electronic component 1C of the fourth embodiment, a capacitor element 3C includes a plurality of first flat plate electrodes 31C, a plurality of second flat plate electrodes 32C, a first support conductor 37, and a second support conductor 38. The first flat plate electrode 31C, the second flat plate electrode 32C, the first support conductor 37, and the second support conductor 38 correspond to an example of an “outer surface conductor” described in the claims.

The plurality of first flat plate electrodes 31C penetrate the glass board 10 from the first side surface 10s1 to the second side surface 10s2. Therefore, the plurality of first flat plate electrodes 31C extend in the width direction (Y direction) in a state of being embedded in the glass board 10. The first flat plate electrode 31C extends in a direction parallel to the YZ plane. All the first flat plate electrodes 31C are arranged in parallel along the X direction.

The plurality of second flat plate electrodes 32C penetrate the glass board 10 from the first side surface 10s1 to the second side surface 10s2. Therefore, the plurality of second flat plate electrodes 32C extend in the width direction (Y direction) in a state of being embedded in the glass board 10. The second flat plate electrode 32C extends in a direction parallel to the YZ plane. All the second flat plate electrodes 32C are arranged in parallel along the X direction.

The first support conductor 37 penetrates the glass board 10 from the first side surface 10s1 to the second side surface 10s2. Therefore, the first support conductor 37 extends in the width direction (Y direction) in a state of being embedded in the glass board 10. The first support conductor 37 includes a first portion 371 extending in a direction parallel to the XY plane and a second portion 372 connected to the first portion 371 and extending in a direction parallel to the YZ plane. The first portion 371 is arranged on the top surface 10t side, and the second portion 372 is arranged on the second end surface 10e2 side. A plurality of first flat plate electrodes 31C are connected to the first portion 371. The second portion 372 is connected to the second terminal electrode 42.

The second support conductor 38 penetrates the glass board 10 from the first side surface 10s1 to the second side surface 10s2. Therefore, the second support conductor 38 extends in the width direction (Y direction) in a state of being embedded in the glass board 10. The second support conductor 38 includes a first portion 381 extending in a direction parallel to the XY plane and a second portion 382 connected to the first portion 381 and extending in a direction parallel to the YZ plane. The first portion 381 is arranged on the bottom surface 10b side, and the second portion 382 is arranged on the first end surface 10e1 side. A plurality of first flat plate electrodes 31C are connected to the first portion 381. The second portion 382 is connected to the first terminal electrode 41.

The plurality of first flat plate electrodes 31C and the plurality of second flat plate electrodes 32C are alternately arranged along the X direction. That is, the plurality of first flat plate electrodes 31C and the plurality of second flat plate electrodes 32C form a comb teeth structure. A part of the glass board 10 exists between the first flat plate electrode 31C and the second flat plate electrode 32C. That is, a part of the glass board 10 functions as a dielectric of the capacitor element 3C.

The electronic component 1C of the fourth embodiment has the same effect as that of the electronic component 1B of the third embodiment. That is, since the first side surface 10sl and the second side surface 10s2 on which the first flat plate electrode 31C and the second flat plate electrode 32C are provided are surfaces different from the bottom surface 10b on which the first terminal electrode 41 and the second terminal electrode 42 are provided, the first flat plate electrode 31C and the second flat plate electrode 32C and the first terminal electrode 41 and the second terminal electrode 42 can be designed without being affected by each other, and the degree of freedom in designing the electronic component 1C is improved.

In addition, since the first terminal electrode 41 and the second terminal electrode 42 each penetrate the glass board 10 from the first side surface 10s1 to the second side surface 10s2, the first terminal electrode 41 and the second terminal electrode 42 each extend in the width direction (Y direction) from the first side surface 10s1 to the second side surface 10s2 in a state of being embedded in the glass board 10. As a result, the bending strength of the glass board 10 in the height direction (Z direction) can be improved.

In addition, since the height dimension H is smaller than the width dimension W, the height dimension H of the glass board 10 can be reduced, whereby the height of the electronic component 1C can be reduced.

The plurality of first flat plate electrodes 31C extend in the width direction (Y direction) in a state of being embedded in the glass board 10. Therefore, the bending strength of the glass board 10 in the height direction (Z direction) can be further improved.

The plurality of second flat plate electrodes 32C extend in the width direction (Y direction) in a state of being embedded in the glass board 10. Therefore, the bending strength of the glass board 10 in the height direction (Z direction) can be further improved.

### Fifth Embodiment

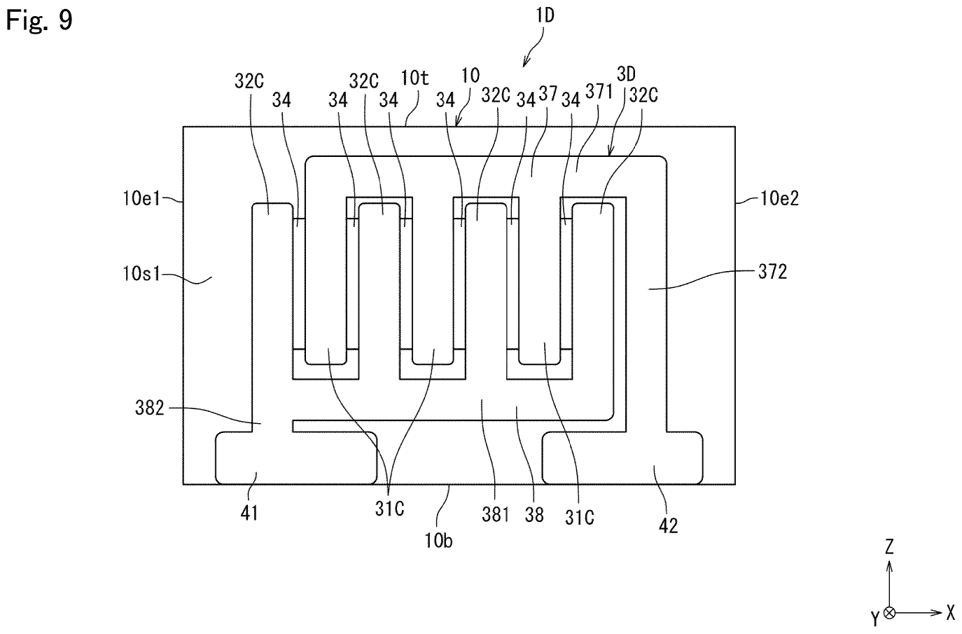

FIG. 9 is a side view of a fifth embodiment of an electronic component as viewed from a first side surface side. The fifth embodiment is different from the fourth embodiment in the configuration of the dielectric. This different configuration will be described below. The other configurations are the same as those of the fourth embodiment, and are denoted by the same reference numerals as those of the fourth embodiment, and the description thereof will be omitted.

As shown in FIG. 9, in an electronic component 1D of the fifth embodiment, the capacitor element 3C has a dielectric 34 between the first flat plate electrode and the second flat plate electrode. The dielectric 34 is made of a material different from the glass material of the glass board 10. The glass material is a material in an amorphous state that is not crystallized. The dielectric 34 is made of, for example, crystallized glass, air, a high dielectric material other than glass, or the like.

In the electronic component 1D of the fifth embodiment, a material having a dielectric constant higher than that of the glass board 10 is used for the dielectric 34, so that a large capacitance can be obtained. In addition, by using a material having a dielectric loss smaller than that of the glass board for the dielectric 34, a high Q value can be obtained.

Further, the electronic component 1D of the fifth embodiment has the same effect as that of the electronic component 1C of the fourth embodiment in other configurations.

### Sixth Embodiment

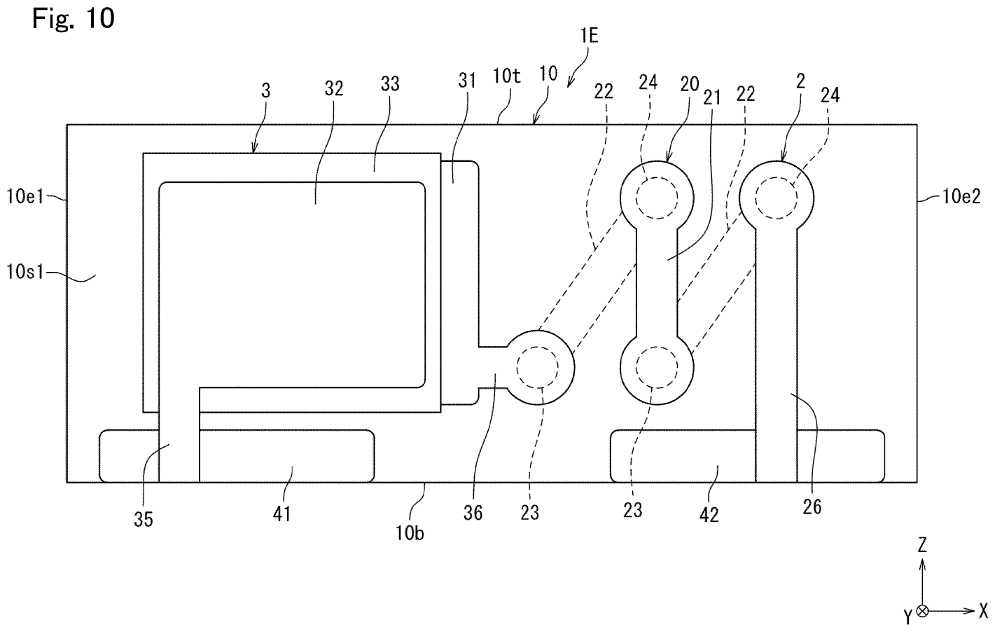

FIG. 10 is a side view of a sixth embodiment of an electronic component as viewed from a first side surface side. The sixth embodiment is different from the first embodiment in the configuration of the passive element. This different configuration will be described below. The other configurations are the same as those of the first embodiment, and are denoted by the same reference numerals as those of the first embodiment, and the description thereof will be omitted.

As shown in FIG. 10, in an electronic component 1E of the sixth embodiment, the passive element includes an inductor element 2 and a capacitor element 3. The inductor element 2 has the same configuration as that of the inductor element 2 of the electronic component 1 of the first embodiment. The capacitor element 3 has the same configuration as that of the capacitor element 3 of the electronic component 1B of the third embodiment. The inductor element 2 is arranged on the second end surface 10e2 side (second terminal electrode 42 side), and the capacitor element 3 is arranged on the first end surface 10e1 side (first terminal electrode 41 side). The inductor element 2 and the capacitor element 3 are electrically connected in series.

The inductor element 2 includes a coil 20 and a second lead conductor 26. The coil 20 includes a first coil conductor 21, a second coil conductor 22, a first through conductor 23, and a second through conductor 24. The first coil conductor 21 is provided on the first side surface 10s1. The second coil conductor 22 is provided on the second side surface 10s2. The first through conductor 23 and the second through conductor 24 penetrate the glass board 10 from the first side surface 10s1 to the second side surface 10s2. The second lead conductor 26 is connected to the second terminal electrode 42.

The capacitor element 3 includes a first flat plate electrode 31, a second flat plate electrode 32, a dielectric film 33, a first lead conductor 35, and a second lead conductor 36. The first flat plate electrode 31, the second flat plate electrode 32, the first lead conductor 35, and the second lead conductor 36 are provided above the first side surface 10s1. The first lead conductor 35 is connected to the first terminal electrode 41. The second lead conductor 36 is connected to the first through conductor 23 which is the first end of the coil 20.

Since the electronic component 1E of the sixth embodiment includes the inductor element 2 and the capacitor element 3, an LC circuit can be realized. The number of each of the inductor element 2 and the capacitor element 3 may be plural.

Further, the electronic component 1E of the sixth embodiment has the same effects as those of the electronic component 1 of the first embodiment and the electronic component 1B of the third embodiment in other configurations.

### Seventh Embodiment

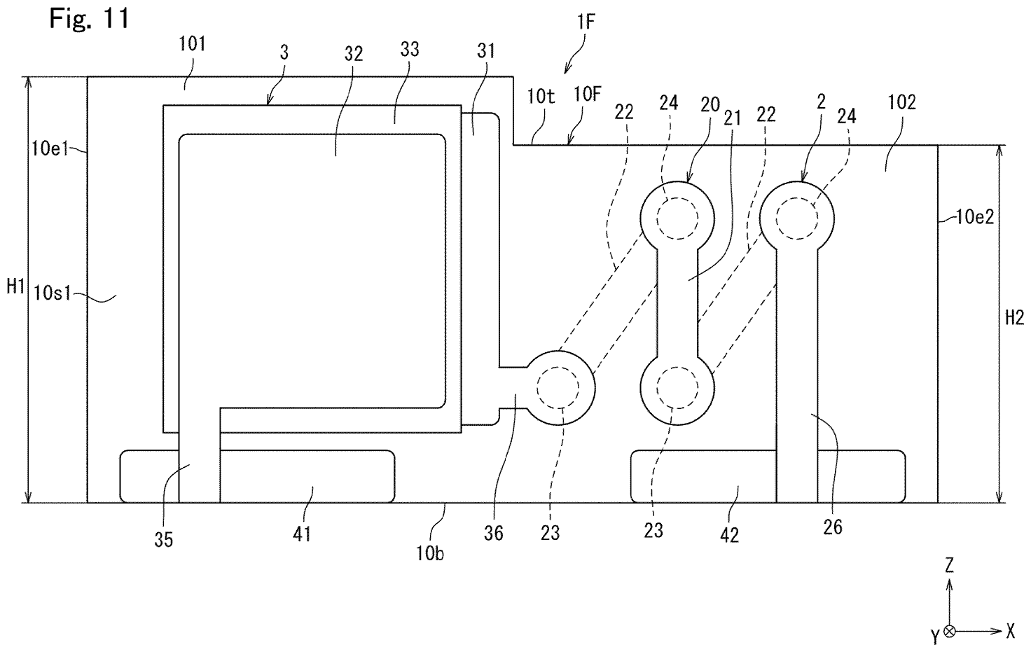

FIG. 11 is a side view of a seventh embodiment of an electronic component as viewed from a first side surface side. The seventh embodiment is different from the sixth embodiment in the configuration of the glass board. This different configuration will be described below. The other configurations are the same as those of the sixth embodiment, and are denoted by the same reference numerals as those of the sixth embodiment, and the description thereof will be omitted.

As shown in FIG. 11, in an electronic component 1F of the seventh embodiment, a glass board 10F has a first portion 101 and a second portion 102. A height dimension H2 of the second portion 102 is smaller than a height dimension H1 of the first portion 101. The height dimension H1 of the first portion 101 and the height dimension H2 of the second portion 102 are smaller than a width dimension W of the glass board 10F. The capacitor element 3 is provided in the first portion 101, and the inductor element 2 is provided in the second portion 102.

In the electronic component 1F of the seventh embodiment, the space provided in the step in the height direction between the first portion 101 and the second portion 102 can be effectively used. Note that three or more portions having different height dimensions may be provided on the glass board 10F, and a plurality of steps may be provided on the glass board 10F.

Furthermore, the electronic component 1F of the seventh embodiment has the same effect as that of the electronic component 1E of the sixth embodiment in other configurations.

### Eighth Embodiment

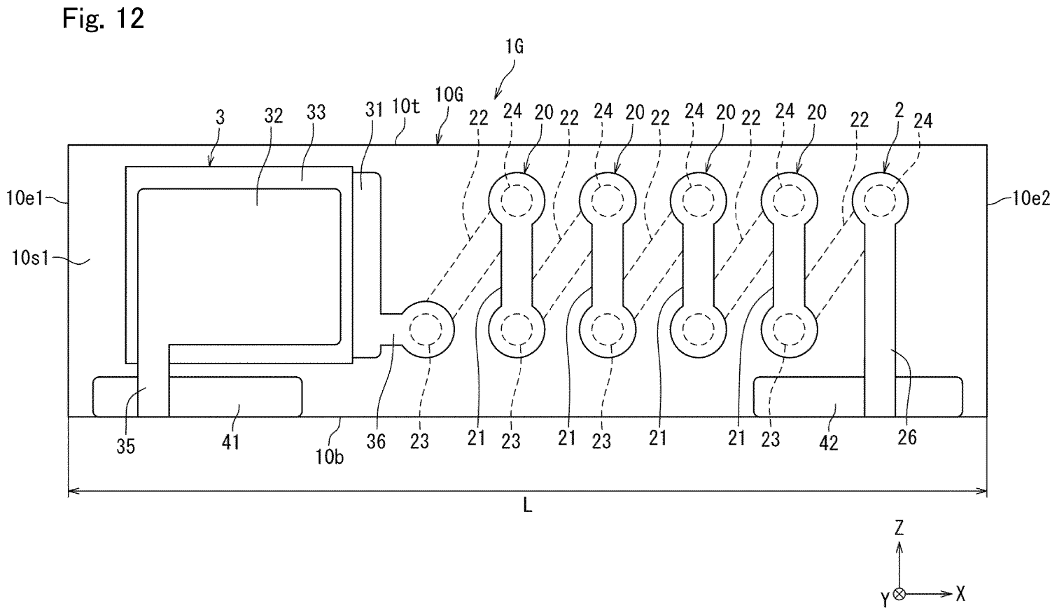

FIG. 12 is a side view of an electronic component according to an eighth embodiment as viewed from a first side surface side. The eighth embodiment is different from the sixth embodiment in the configuration of the glass board. This different configuration will be described below. The other configurations are the same as those of the sixth embodiment, and are denoted by the same reference numerals as those of the sixth embodiment, and the description thereof will be omitted.

As shown in FIG. 12, in an electronic component 1G of the eighth embodiment, the length dimension L of the glass board 10G is twice or more the width dimension W of the glass board 10G. The axial length of the coil 20 is twice or more the axial length of the coil 20 of the sixth embodiment.

In the electronic component 1G of the eighth embodiment, since the length dimension L of the glass board 10G can be increased, the inductor element 2 and the capacitor element 3 can be increased in size, and the performance can be improved. In addition, since it is possible to increase the size by increasing the length dimension L, it is not necessary to increase the width dimension of the glass board 10G. For this reason, it is not necessary to increase the lengths of the terminal electrodes 41 and 42 in the width direction, and manufacturing is facilitated, and it is not necessary to increase the lengths of the through conductors 23 and 24 in the width direction, and the diameters of the through conductors 23 and 24 can be reduced.

Furthermore, the electronic component 1G of the eighth embodiment has the same effect as that of the electronic component 1E of the sixth embodiment in other configurations.

### Ninth Embodiment

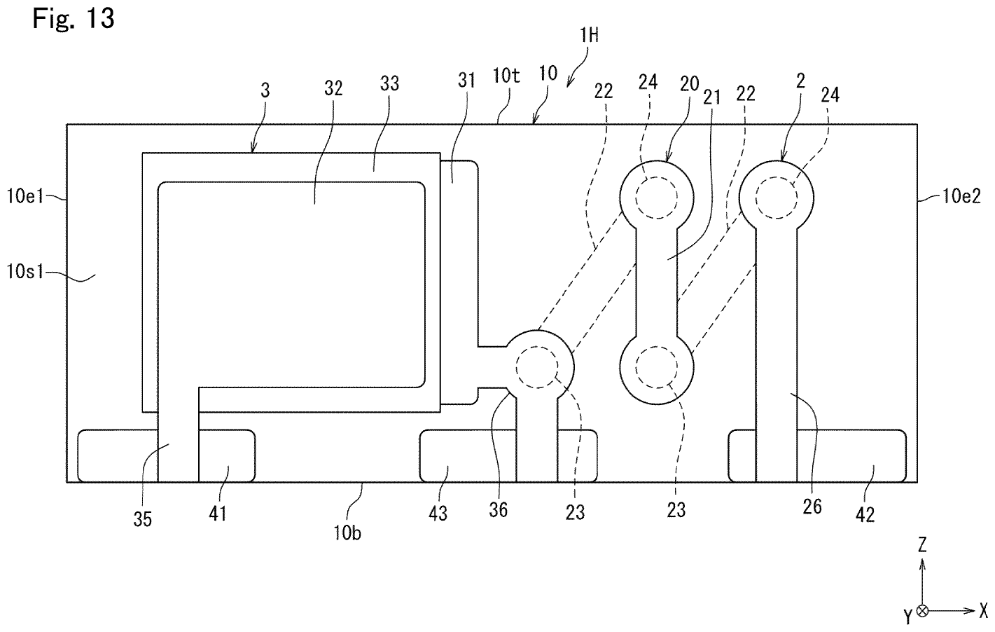

FIG. 13 is a side view of a ninth embodiment of an electronic component as viewed from a first side surface side. The ninth embodiment is different from the sixth embodiment in the number of terminal electrodes. This different configuration will be described below. The other configurations are the same as those of the sixth embodiment, and are denoted by the same reference numerals as those of the sixth embodiment, and the description thereof will be omitted.

As shown in FIG. 13, an electronic component 1H of the ninth embodiment further includes a third terminal electrode 43. The third terminal electrode 43 is embedded in the glass board 10 so as to be exposed from the bottom surface 10b. The third terminal electrode 43 penetrates the glass board 10 from the first side surface 10s1 to the second side surface 10s2.

The third terminal electrode 43 is located between the first terminal electrode 41 and the second terminal electrode 42 along the X direction. The third terminal electrode 43 is connected between the inductor element 2 and the capacitor element 3. Specifically, the third terminal electrode 43 is connected to the second lead conductor 36.

In the electronic component 1H of the ninth embodiment, more terminal electrodes 41, 42, and 43 can be provided, and a more complicated circuit can be realized. In addition, since the third terminal electrode 43 extends in the width direction (Y direction) in a state of being embedded in the glass board 10, the bending strength in the height direction (Z direction) of the glass board 10 can be further improved. There may be four or more terminal electrodes.

Furthermore, the electronic component 1H of the ninth embodiment has the same effect as that of the electronic component 1E of the sixth embodiment in other configurations.

### Tenth Embodiment

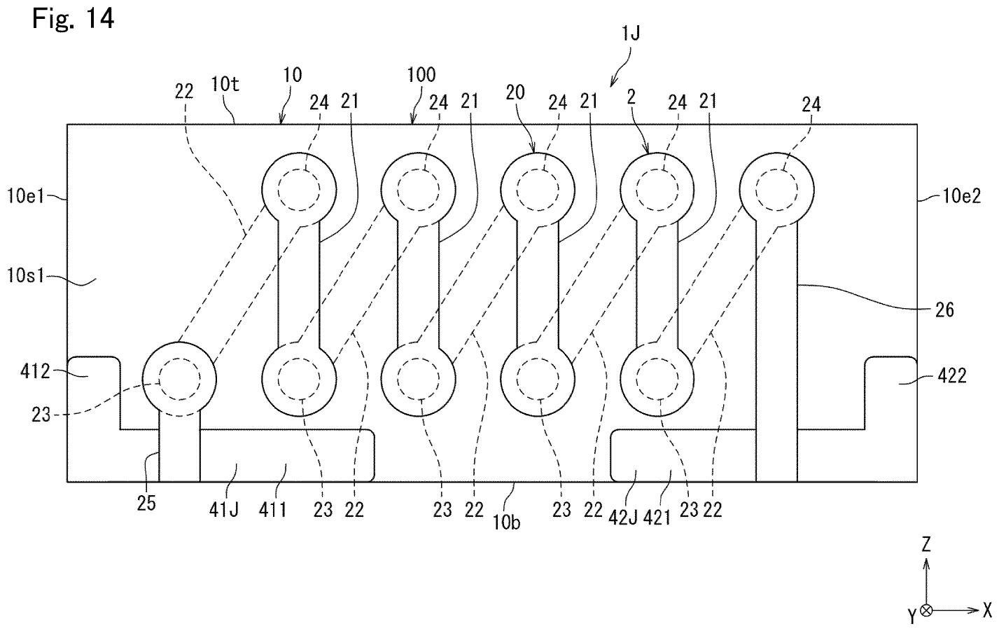

FIG. 14 is a side view of a tenth embodiment of an electronic component as viewed from a first side surface side. The tenth embodiment is different from the first embodiment in the configuration of the terminal electrode. This different configuration will be described below. The other configurations are the same as those of the first embodiment, and are denoted by the same reference numerals as those of the first embodiment, and the description thereof will be omitted.

As shown in FIG. 14, in an electronic component 1J of the tenth embodiment, a first terminal electrode 41J is further exposed from the first end surface 10e1. Specifically, the first terminal electrode 41J has a first portion 411 and a second portion 412 connected to the first portion 411. The first portion 411 extends along the bottom surface 10b, and the second portion 412 extends along the first end surface 10e1. That is, the first terminal electrode 41J is an L-shaped electrode. The first portion 411 is exposed from the bottom surface 10b, and the second portion 412 is exposed from the first end surface 10e1. The first portion 411 and the second portion 412 each penetrate the glass board 10 from the first side surface 10s1 to the second side surface 10s2.

A second terminal electrode 42J is further exposed from the second end surface 10e2. Specifically, the second terminal electrode 42J has a first portion 421 and a second portion 422 connected to the first portion 421. The first portion 421 extends along the bottom surface 10b, and the second portion 422 extends along the second end surface 10e2. That is, the second terminal electrode 42J is an L-shaped electrode. The first portion 421 is exposed from the bottom surface 10b, and the second portion 422 is exposed from the second end surface 10e2. The first portion 421 and the second portion 422 each penetrate the glass board 10 from the first side surface 10s1 to the second side surface 10s2.

In the electronic component 1J of the tenth embodiment, when the electronic component 1J is mounted on the mounting substrate such that the bottom surface 10b of the glass board 10 faces the mounting substrate, solder also adheres to the portion of the first terminal electrode 41J exposed from the first end surface 10e1, so that the inclination of the electronic component 1J and the solder ball can be suppressed, and the mounting strength can be improved. Similarly, solder also adheres to the portion of the second terminal electrode 42J exposed from the second end surface 10e2, so that the inclination of the electronic component 1J and the solder ball can be suppressed, and the mounting strength can be improved.

Further, the electronic component 1J of the tenth embodiment has the same effect as that of the electronic component 1 of the first embodiment in other configurations.

### Eleventh Embodiment

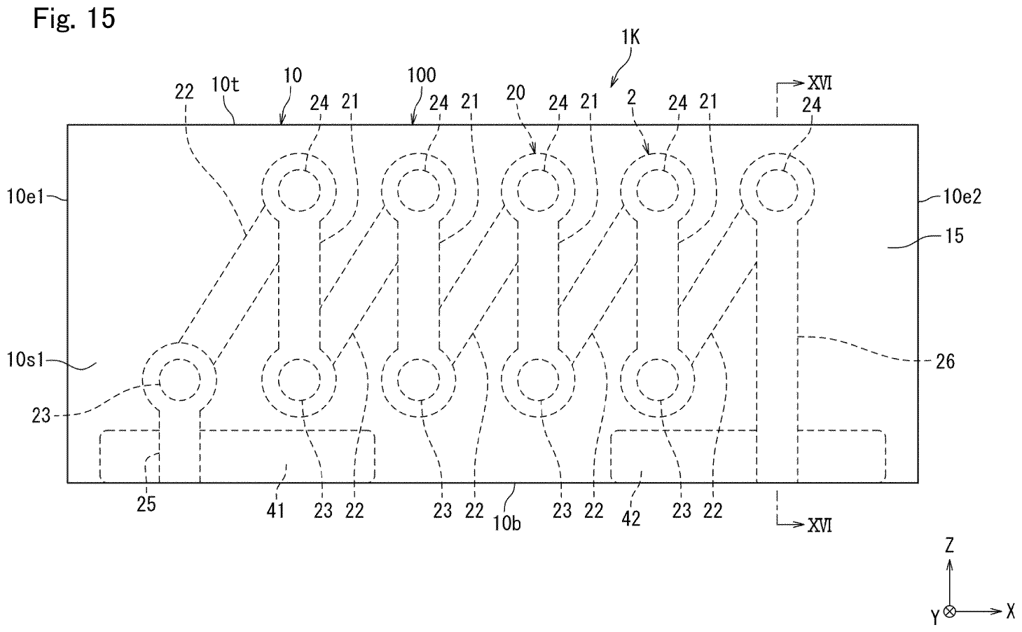

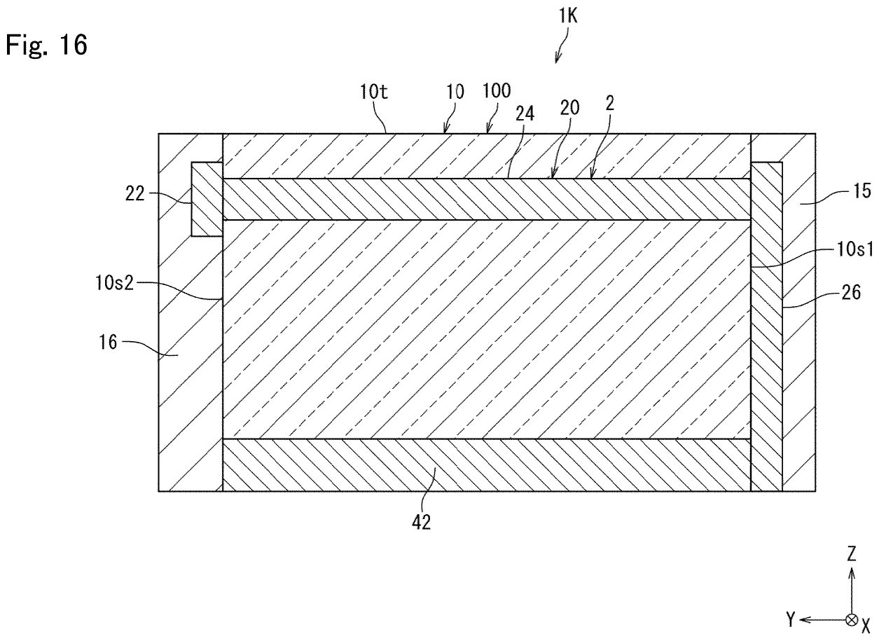

FIG. 15 is a side view of an eleventh embodiment of an electronic component as viewed from a first side surface side. FIG. 16 is a cross-sectional view taken along line XVI-XVI of FIG. 15. The eleventh embodiment is different from the first embodiment in that a protective layer is provided. This different configuration will be described below. The other configurations are the same as those of the first embodiment, and are denoted by the same reference numerals as those of the first embodiment, and the description thereof will be omitted.

As shown in FIGS. 15 and 16, the electronic component 1K of the eleventh embodiment has a first protective layer 15 and a second protective layer 16. The electronic component 1K may have one of the first protective layer 15 and the second protective layer 16.

The first protective layer 15 is provided on the first side surface 10s1 and covers the first coil conductor 21, the first lead conductor 25, and the second lead conductor 26. When viewed from a direction orthogonal to the first side surface 10s1, the first protective layer 15 has the same size as that of the first side surface 10s1 of the glass board 10. The first protective layer 15 has an insulating property and is made of, for example, a resin such as epoxy or polyimide.

Preferably, the first protective layer 15 is colored. The first protective layer 15 is colored, for example, green or blue, and the transparency of the first protective layer 15 is lower than the transparency of the glass material of the glass board 10. The glass material is a material in an amorphous state that is not crystallized.

The second protective layer 16 is provided on the second side surface 10s2 and covers the second coil conductor 22. When viewed from the direction orthogonal to the second side surface 10s2, the second protective layer 16 has the same size as that of the second side surface 10s2 of the glass board 10. The second protective layer 16 has an insulating property and is made of, for example, a resin such as epoxy or polyimide.

Preferably, the second protective layer 16 is colored. The second protective layer 16 is colored, for example, green or blue, and the transparency of the second protective layer 16 is lower than the transparency of the glass material of the glass board 10.

In the electronic component 1K of the eleventh embodiment, since the first protective layer 15 is provided, the first coil conductor 21, the first lead conductor 25, and the second lead conductor 26 are protected, and the reliability is improved. In addition, the exposed region of the glass board 10 is reduced, and the strength of the electronic component 1K can be improved. When the terminal electrodes 41 and 42 are mounted on the mounting substrate using solder, it is possible to prevent the solder from adhering to the first coil conductor 21, the first lead conductor 25, and the second lead conductor 26. In addition, although stress is generated in the glass board 10 due to a difference in linear expansion coefficient between the first protective layer 15 and the glass board 10, since the width dimension W of the glass board 10 is large, occurrence of warpage in the width direction (Y direction) of the glass board 10 can be reduced. Preferably, since the first protective layer 15 is colored, it can be detected by a laser sensor or a camera.

The same applies to the second protective layer 16. That is, the second coil conductor 22 is protected and reliability is improved. In addition, the exposed region of the glass board 10 is reduced, and the strength of the electronic component 1K can be improved. In addition, it is possible to prevent the solder from adhering to the second coil conductor 22. In addition, even if the second protective layer 16 is provided, since the width dimension W of the glass board 10 is large, occurrence of warpage in the width direction (Y direction) of the glass board 10 can be reduced. Preferably, since the second protective layer 16 is colored, it can be detected by a laser sensor or a camera.

Further, the electronic component 1K of the eleventh embodiment has the same effect as that of the electronic component 1 of the first embodiment in other configurations.

### Twelfth Embodiment

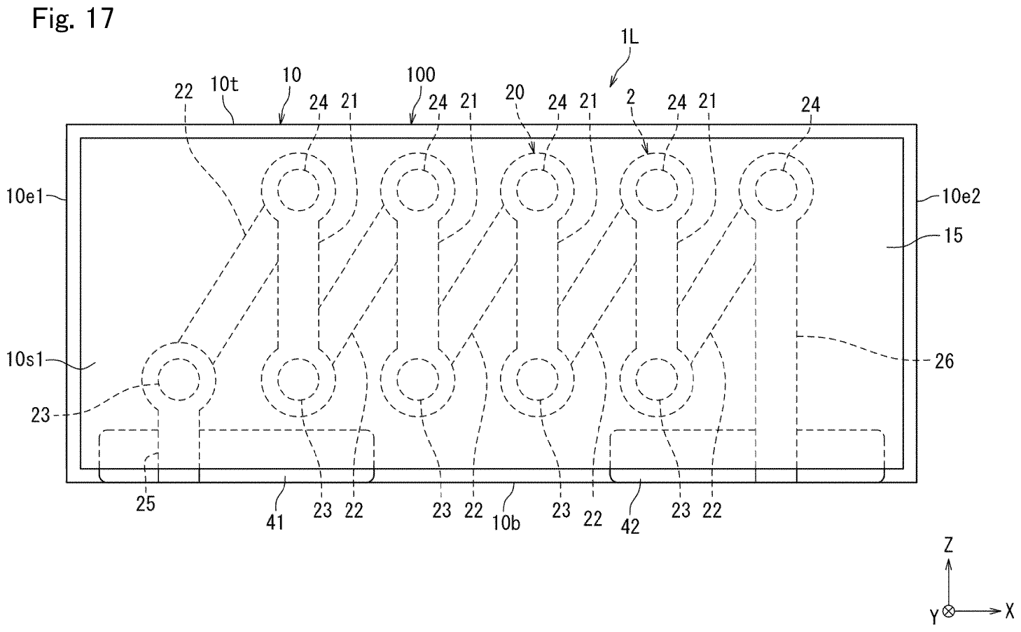

FIG. 17 is a side view of a twelfth embodiment of an electronic component as viewed from a first side surface side. The twelfth embodiment is different from the eleventh embodiment in the size of the protective layer. This different configuration will be described below. The other configurations are the same as those of the eleventh embodiment, and are denoted by the same reference numerals as those of the eleventh embodiment, and the description thereof will be omitted.

As shown in FIG. 17, in the electronic component 1L of the twelfth embodiment, the first protective layer 15 is located inside the outer periphery of the first side surface 10s1 of the glass board 10 when viewed from the direction orthogonal to the first side surface 10s1. Similarly, when viewed from the direction orthogonal to the second side surface 10s2, the second protective layer 16 is located inside the outer periphery of the second side surface 10s2 of the glass board 10. It is sufficient that only the first protective layer 15 among the first protective layer 15 and the second protective layer 16 satisfies the above configuration.

In the electronic component 1L of the twelfth embodiment, since the first protective layer 15 is smaller than the outer periphery of the first side surface 10s1, processing of the glass board 10 is facilitated. For example, when the glass board 10 is cut, a portion of the glass board 10 to be cut can be crystallized and cut by etching. In addition, for example, in the case of cutting with a dicer, it is possible to prevent the first protective layer 15 from being peeled off from the glass board 10 by a load of the dicer.

The same applies to the second protective layer 16. That is, since the second protective layer 16 is smaller than the outer periphery of the second side surface 10s2, processing of the glass board 10 is facilitated when the glass board 10 is cut. In addition, when the glass board 10 is cut with a dicer, it is possible to prevent the second protective layer 16 from being peeled off from the glass board 10 by the load of the dicer.

Further, the electronic component 1L of the twelfth embodiment has the same effect as that of the electronic component 1K of the eleventh embodiment in other configurations.

### Thirteenth Embodiment

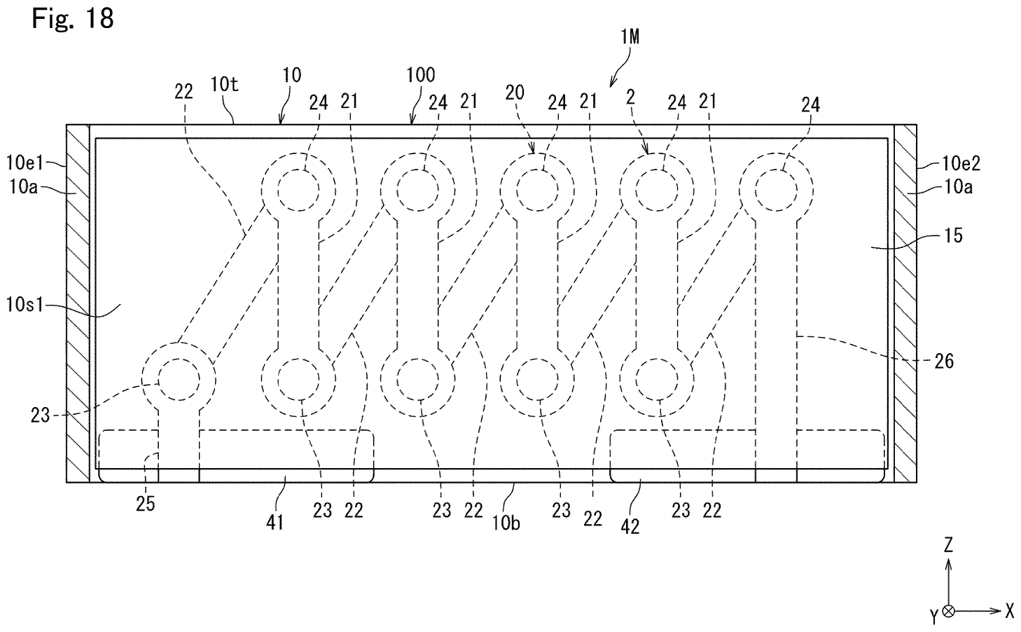

FIG. 18 is a side view of a thirteenth embodiment of an electronic component as viewed from a first side surface side. The thirteenth embodiment is different from the twelfth embodiment in the configuration of the end surface of the glass board. This different configuration will be described below. The other configurations are the same as those of the twelfth embodiment, and are denoted by the same reference numerals as those of the twelfth embodiment, and the description thereof will be omitted.

As shown in FIG. 18, in an electronic component 1M of the thirteenth embodiment, the first end surface 10e1 of the glass board 10 is colored. Specifically, the first end surface 10e1 of the glass board 10 is formed of a crystallized portion 10a. In FIG. 18, the crystallized portion 10a is indicated by hatching for convenience. The crystallized portion 10a is a portion which is crystallized in the glass board 10. The transparency of the crystallized portion 10a is lower than the transparency of the non-crystallized glass material of the glass board 10. The crystallized portion 10a can be formed by irradiating a portion of the glass board 10 to be crystallized with ultraviolet rays and then performing heat treatment (For example, firing).

Similarly, the second end surface 10e2 of the glass board 10 is colored. Specifically, the second end surface 10e2 of the glass board 10 is formed of a crystallized portion 10a. It is sufficient that only the first end surface 10e1 among the first end surface 10e1 and the second end surface 10e2 satisfies the above configuration.

In the electronic component 1M of the thirteenth embodiment, since the first end surface 10e1 is colored, it can be detected by a laser sensor or a camera. Similarly, since the second end surface 10e2 is colored, it can be detected by a laser sensor or a camera. In addition to the crystallized portion 10a, the end surface may be colored by another method such as coloring separately. For example, a colored resin layer may be provided on the end surface.

Furthermore, the electronic component 1M of the thirteenth embodiment has the same effect as that of the electronic component 1L of the twelfth embodiment in other configurations.

### Fourteenth Embodiment

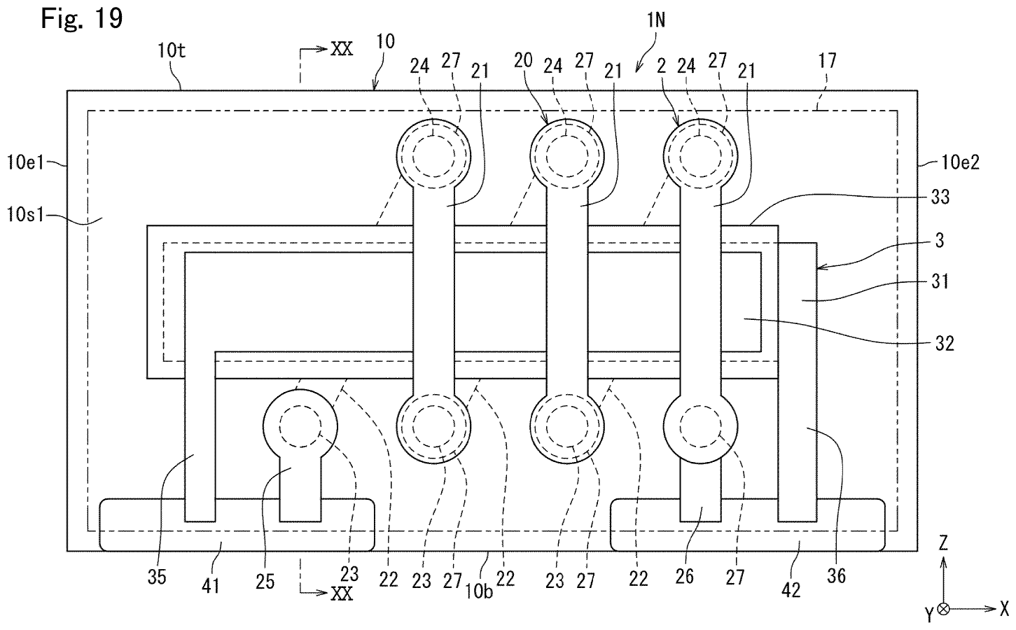

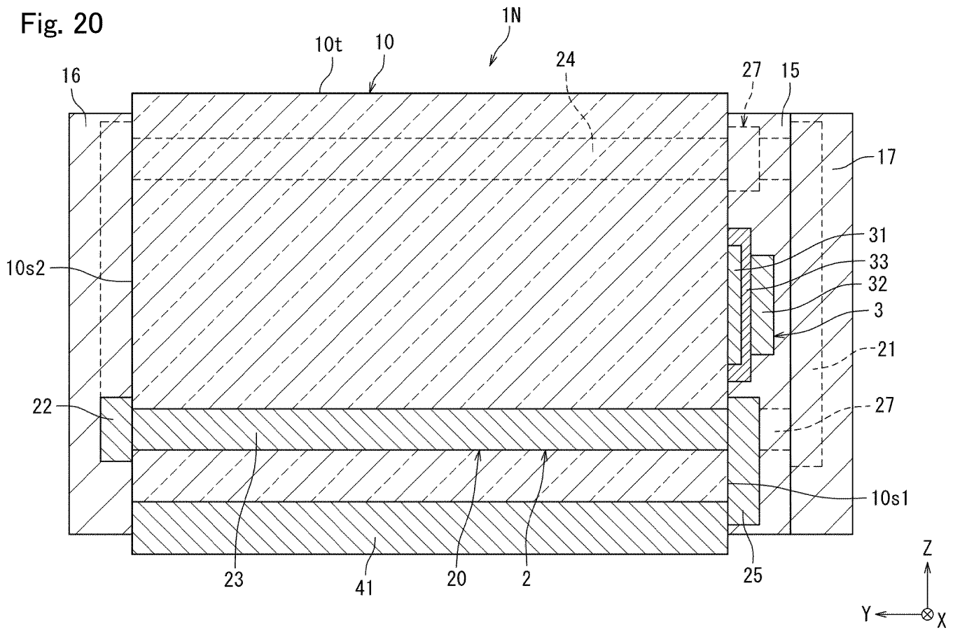

FIG. 19 is a side view of a fourteenth embodiment of an electronic component as viewed from a first side surface side. FIG. 20 is a cross-sectional view taken along line XX-XX of FIG. 19. The fourteenth embodiment is different from the third embodiment in that an inductor element is added. This different configuration will be described below. The other configurations are the same as those of the third embodiment, and are denoted by the same reference numerals as those of the third embodiment, and the description thereof will be omitted.

As shown in FIGS. 19 and 20, in the electronic component 1N of the fourteenth embodiment, the first coil conductor 21 of the inductor element 2 is provided on the first flat plate electrode 31 and the second flat plate electrode 32 of the capacitor element 3 on the first side surface 10s1. The first flat plate electrode 31 and the second flat plate electrode 32 correspond to an example of an “outer surface conductor” described in the claims. The first coil conductor 21 corresponds to an example of a “wiring layer” described in the claims.

The inductor element 2 has the same configuration as that of the inductor element 2 of the first embodiment. The capacitor element 3 has the same configuration as that of the capacitor element 3 of the third embodiment. Therefore, the inductor element 2 and the capacitor element 3 will not be described in detail.

The electronic component 1N further includes a first protective layer 15, a second protective layer 16, and a third protective layer 17. The first protective layer 15 is provided on the first side surface 10s1, the second protective layer 16 is provided on the second side surface 10s2, and the third protective layer 17 is provided on the first protective layer 15. The first protective layer 15, the second protective layer 16, and the third protective layer 17 have the same configurations as those of the first protective layer 15 and the second protective layer 16 of the twelfth embodiment. Therefore, detailed description of the first protective layer 15, the second protective layer 16, and the third protective layer 17 is omitted.

The capacitor element 3 includes a first flat plate electrode 31, a second flat plate electrode 32, a dielectric film 33, a first lead conductor 35, and a second lead conductor 36. The first flat plate electrode 31, the second flat plate electrode 32, the dielectric film 33, the first lead conductor 35, and the second lead conductor 36 are provided on the first side surface 10s1. The capacitor element 3 is covered with the first protective layer 15. The first lead conductor 35 is connected to the first terminal electrode 41, and the second lead conductor 36 is connected to the second terminal electrode 42.

The inductor element 2 includes a coil 20, a first lead conductor 25, and a second lead conductor 26. The first lead conductor 25 and the second lead conductor 26 are provided on the first side surface 10s1 and covered with the first protective layer 15. The first lead conductor 25 is connected to the first terminal electrode 41, and the second lead conductor 26 is connected to the second terminal electrode 42. That is, the inductor element 2 and the capacitor element 3 are electrically connected in parallel.

The coil 20 includes a first coil conductor 21, a second coil conductor 22, a first through conductor 23, and a second through conductor 24. Each of the first through conductor 23 and the second through conductor 24 penetrates the glass board 10 from the first side surface 10s1 to the second side surface 10s2. The second coil conductor 22 is provided on the second side surface 10s2. The second coil conductor 22 is covered with the second protective layer 16.

The first coil conductor 21 is provided on the first protective layer 15 and covered with the third protective layer 17. The first coil conductor 21 is connected to the first through conductor 23 and the second through conductor 24 via the via conductor 27 penetrating the first protective layer 15. That is, the first coil conductor 21 is located on the first flat plate electrode 31 and the second flat plate electrode 32.

In other words, the first flat plate electrode 31 and the second flat plate electrode 32 are arranged inside the coil 20. Specifically, a part of the capacitor element 3 is provided between the first coil conductor 21 and the second coil conductor 22 of the coil 20 and between the first through conductor 23 and the second through conductor 24. The “inside the coil 20” refers to a region surrounded by two surfaces in contact with the inner peripheries of the first through conductor 23 and the second through conductor 24 facing each other and two surfaces in contact with the inner peripheries of the first coil conductor 21 and the second coil conductor 22 facing each other.

In the electronic component 1N of the fourteenth embodiment, a more complicated circuit can be realized without increasing the height dimension of the electronic component 1N.

Further, the electronic component 1N of the fourteenth embodiment has the same effects as those of the electronic component 1 of the first embodiment and the electronic component 1B of the third embodiment in other configurations.

Note that the present disclosure is not limited to the above-described embodiments, and can be modified in design without departing from the gist of the present disclosure. For example, the respective feature points of the first to fourteenth embodiments may be variously combined.

The present disclosure includes the following aspects.

<1> An electronic component comprising a glass board including a top surface, a bottom surface, a first side surface, and a second side surface; an outer surface conductor that is provided on at least the first side surface among the first side surface and the second side surface and is at least a part of a passive element; and a terminal electrode embedded in the glass board so as to be exposed from the bottom surface and electrically connected to the outer surface conductor. The terminal electrode penetrates the glass board from the first side surface to the second side surface. Also, and a height dimension of the glass board, which is a distance between the top surface and the bottom surface, is smaller than a width dimension of the glass board, which is a distance between the first side surface and the second side surface.

<2> The electronic component according to <1>, in which the passive element is an inductor element, and in which the inductor element includes a through conductor connected to the outer surface conductor and penetrating the glass board from the first side surface to the second side surface.

<3> The electronic component according to <2>, in which the inductor element includes a coil that is spirally wound along an axis and includes the outer surface conductor and the through conductor, and in which the axis of the coil is parallel to the bottom surface.

<4> The electronic component according to <2>, in which the inductor element includes a coil that is spirally wound along an axis and includes the outer surface conductor and the through conductor, and in which the axis of the coil is perpendicular to the bottom surface.

<5> The electronic component according to <1>, in which the passive element is a capacitor element, in which the outer surface conductor includes a first flat plate electrode provided on the first side surface and a second flat plate electrode provided on the first flat plate electrode, and in which the capacitor element includes a dielectric film provided between the first flat plate electrode and the second flat plate electrode.

<6> The electronic component according to <1>, in which the passive element is a capacitor element, and in which the outer surface conductor includes a first flat plate electrode penetrating the glass board from the first side surface to the second side surface, and a second flat plate electrode facing the first flat plate electrode and penetrating the glass board from the first side surface to the second side surface.

<7> The electronic component according to <6>, in which the capacitor element includes a dielectric made of a material different from a glass material of the glass board between the first flat plate electrode and the second flat plate electrode.

<8 The electronic component according to <1>, in which the passive element includes an inductor element and a capacitor element.

<9> The electronic component according to any one of <1> to <8>, in which the glass board has a first portion and a second portion having a height dimension smaller than a height dimension of the first portion.

<10> The electronic component according to any one of <1> to <9>, in which the glass board includes a first end surface and a second end surface, and in which a length dimension of the glass board, which is a distance between the first end surface and the second end surface, is twice or more a width dimension of the glass board.

<11> The electronic component according to any one of <1> to <10>, in which there are three or more terminal electrodes.

<12> The electronic component according to any one of <1> to <11>, in which the glass board includes a first end surface and a second end surface, and in which the terminal electrode is further exposed from the first end surface.

<13> The electronic component according to any one of <1> to <12>, further including a protective layer provided on the first side surface and covering the outer surface conductor.

<14> The electronic component according to <13>, in which the protective layer is colored.

<15> The electronic component according to <13> or <14>, in which the protective layer is located inside an outer periphery of the first side surface of the glass board when viewed from a direction orthogonal to the first side surface.

<16> The electronic component according to any one of <1> to <15>, in which the glass board includes a first end surface and a second end surface, and in which the first end surface is colored.

<17> The electronic component according to any one of <1> to <16>, further including a wiring layer on the outer surface conductor on the first side surface.

<18> A method for manufacturing an electronic component, the method comprising a step of preparing a glass mother board including a first surface and a second surface; a step of providing, in the first surface, two or more in a direction parallel to a first side, and two or more singulated regions in a direction parallel to the third side, the singulated regions being defined by the first side and a second side that have a length smaller than a distance between the first surface and the second surface and are parallel to each other, and the third side and a fourth side that are orthogonal to the first side and are parallel to each other; a step of forming a through hole penetrating the mother board from the first surface to the second surface in each of all the singulated regions, and filling a conductor in the through hole to form a terminal electrode; a step of forming an outer surface conductor that is at least a part of a passive element on the first surface in each of all the singulated regions; and a step of singulating each of all the singulated regions to manufacture a plurality of electronic components.

What is claimed is:

1. An electronic component comprising:
a glass board comprising a top surface, a bottom surface, a first side surface, and a second side surface;
an outer surface conductor that is on at least the first side surface among the first side surface and the second side surface and is at least a part of a passive element; and
a terminal electrode embedded in the glass board and exposed from the bottom surface and electrically connected to the outer surface conductor,
wherein
the terminal electrode penetrates the glass board from the first side surface to the second side surface, and
a height dimension of the glass board, which is a distance between the top surface and the bottom surface, is smaller than a width dimension of the glass board, which is a distance between the first side surface and the second side surface.

2. The electronic component according to claim 1, wherein
the passive element is an inductor element, and
the inductor element comprises a through conductor connected to the outer surface conductor and penetrating the glass board from the first side surface to the second side surface.

3. The electronic component according to claim 2, wherein
the inductor element comprises a coil that is spirally wound along an axis and comprises the outer surface conductor and the through conductor, and
the axis of the coil is parallel to the bottom surface.

4. The electronic component according to claim 2, wherein
the inductor element comprises a coil that is spirally wound along an axis and comprises the outer surface conductor and the through conductor, and
the axis of the coil is perpendicular to the bottom surface.

5. The electronic component according to claim 1, wherein
the passive element is a capacitor element,
the outer surface conductor comprises a first flat plate electrode on the first side surface and a second flat plate electrode on the first flat plate electrode, and
in which the capacitor element comprises a dielectric film between the first flat plate electrode and the second flat plate electrode.

6. The electronic component according to claim 1, wherein
the passive element is a capacitor element, and
the outer surface conductor comprises a first flat plate electrode penetrating the glass board from the first side surface to the second side surface, and a second flat plate electrode facing the first flat plate electrode and penetrating the glass board from the first side surface to the second side surface.

7. The electronic component according to claim 6, wherein
the capacitor element comprises a dielectric including a material different from a glass material of the glass board between the first flat plate electrode and the second flat plate electrode.

8. The electronic component according to claim 1, wherein
the passive element comprises an inductor element and a capacitor element.

9. The electronic component according to claim 1, wherein
the glass board has a first portion and a second portion having a height dimension smaller than a height dimension of the first portion.

10. The electronic component according to claim 1, wherein
the glass board comprises a first end surface and a second end surface, and
a length dimension of the glass board, which is a distance between the first end surface and the second end surface, is twice or more a width dimension of the glass board.

11. The electronic component according to claim 1, wherein
there are three or more terminal electrodes.

12. The electronic component according to claim 1, wherein
the glass board comprises a first end surface and a second end surface, and
the terminal electrode is further exposed from the first end surface.

13. The electronic component according to claim 1, further comprising:
a protective layer on the first side surface and covering the outer surface conductor.

14. The electronic component according to claim 13, wherein
the protective layer is colored.

15. The electronic component according to claim 13, wherein
the protective layer is inside an outer periphery of the first side surface of the glass board when viewed from a direction orthogonal to the first side surface.

16. The electronic component according to claim 1, wherein
the glass board comprises a first end surface and a second end surface, and
the first end surface is colored.

17. The electronic component according to claim 1, further comprising:
a wiring layer on the outer surface conductor on the first side surface.

18. The electronic component according to claim 2, wherein
the glass board has a first portion and a second portion having a height dimension smaller than a height dimension of the first portion.

19. The electronic component according to claim 2, wherein
the glass board comprises a first end surface and a second end surface, and
a length dimension of the glass board, which is a distance between the first end surface and the second end surface, is twice or more a width dimension of the glass board.

20. A method for manufacturing an electronic component, the method comprising:
preparing a glass mother board comprises a first surface and a second surface;
providing, in the first surface, two or more in a direction parallel to a first side, and two or more singulated regions in a direction parallel to a third side, the singulated regions being defined by the first side and a second side that have a length smaller than a distance between the first surface and the second surface and are parallel to each other, and the third side and a fourth side that are orthogonal to the first side and are parallel to each other;
forming a through hole penetrating the mother board from the first surface to the second surface in each of all the singulated regions, and filling a conductor in the through hole to form a terminal electrode; and
forming an outer surface conductor that is at least a part of a passive element on the first surface in each of all the singulated regions; and
singulating each of all the singulated regions to manufacture a plurality of electronic components.
